(19) United States
(12) Patent Application Publication
(10) Pub. No.: US 2014/0175799 A1
(43) Pub. Date: Jun. 26, 2014

(54) Advanced methods and systems for generating renewable electrical energy

(71) Applicant: JOSEPH AKWO TABE, Silver Spring, MD (US)

(72) Inventor: JOSEPH AKWO TABE, Silver Spring, MD (US)

(21) Appl. No.: 13/726,401

(22) Filed: Dec. 24, 2012

(51) Int. Cl. F03D 9/00

(52) U.S. Cl. CPC F03D 9/002
USPC 290/55

(57) ABSTRACT

Disclosed embodiment provides enclosed wind and hydropower energy generation being disposed with electrical energy generation apparatus, comprising advanced methods and systems for maximizing net impact on wind turbine operations. The enclosed wind and hydropower energy generation provides an effective environment for turbine maintenance scheduling, refurbishment, and replacement. Embodiment comprises advanced methods and systems for generating renewable electrical energy via performance enhancement and reliability.

### FIELD OF THE INVENTION

Embodiments relate to wind power apparatus, methods, and systems for generating renewable electrical energy. Embodiments provide hydropower apparatus, methods, and systems for generating renewable electrical energy. Embodiments further comprise efficient system for monitoring wind turbine plant, hydropower plant, or a combination of both wind turbine plant and hydropower plant, and solar energy system. Each preceding methods and systems provides compressed air apparatus for generating renewable electrical energy. Embodiments further provide methods and systems for energy storage medium.

### BACKGROUND OF THE INVENTION

According to Department Of Energy, our addiction to foreign oil doesn't just undermine our national security and wreak havoc on our environment it cripples our economy and strains the budgets of working families all across America. The energy challenge our country faces are severe and have gone unsolved for far too long. Although wind energy is cleaner, exposable wind energy doesn't really reduce pollution completely at 100% when the wind is not available because other fossil-fired generating units are being run on temporal basis until the wind is available again. Ice throw may occur with the conventional exposable wind turbine, and because ice buildup slows turbine rotation, though are being sensed by turbine control system, the buildup still cause the turbine to shut down, thereby turning the fossil power plant on and adding more pollutant into the environment.

Disclosed embodiments provide exemplary method of enclosing wind turbines, being directed generally to a method for increasing energy capture. Certain embodiments provide a system for controlling the speed of rotation of the wind turbine blades to increase the amount of energy capture. Wind is a form of solar energy caused by the uneven warming of the earth's surface. The air masses have different temperatures and pressures, and are constantly moving to find a balance. The higher the difference in pressure, the swifter the air moves and the stronger the wind. Embodiments provide apparatus for controlling the abundance of energy through a controllable inflow of air from a wind control device. The wind control device further comprises compressed air apparatus operable for controlling atmospheric pressure into an enclosed environment, compressing the atmospheric pressure to enable a compressed air within the enclosed environment. The turbine blades responsive to the pressure from the compressed air, and the compressed air being released back to atmospheric pressure through an exit channel. Embodiments further provide a system propelling wind turbine assembly to generate renewable electrical energy even when there is no existence of natural wind. Some embodiments provide a combination of wind and hydropower apparatus, methods, and systems comprising concentrated devices configured to generate high pressured fluid force for communications with at least turbine generator assembly.

Embodiments further provide energy storage medium comprising microfiber material configured with silicon substrate. Embodiments further provide substrate-microfiber comprising miniaturized non ferrous materials embedded in silicon substrate. Embodiments further provide substrate-microfiber comprising energy transport platform. Certain embodiments provide energy transport platform consisting of glass. WPWW relates to an effective method of producing electrical energy without affecting the environment and without massive consumption of other energies, such as water and fuel. WPWW is an effective social and economic medium for producing renewable electrical energy that is feasible in all environments.

### Anticipated Benefits

WPWW is a combination of wind generating apparatus and wind turbine apparatus that are operatively configured for operation in an enclosed environment. The renewable energy production process will not encounter extreme natural emergencies as seen with conventional wind farms. Further advantages of WPWW will maximize benefit as follows:
   Would increase energy efficiency.
   Would reduce the environmental impact of electrical energy production.
   Would lower the cost of consumer electrical energy.
   Would reduce United States dependence on foreign oil.
   Would present an effective renewable electrical energy production method.
   Would enable wind energy applications to compete with conventional energy plants.
   Would additional path to economic growth
   Would provide a better path to maintenance scheduling and turbine monitoring.

The potential significant value to enable the above numerous benefits include enclosing turbine assemblies inside building structures and proving the building structure with wind generating apparatus that are configured for pulling the outside wind into the building and for generating wind within the building even when there is no outside wind. The application of WPWW would further:
Provide controllable energy supply to meet existing and projected energy demands.
Replace time lost to environmental effect and relieve no naturally occurring wind conditions on land.
Enhance wind reliability and electrical energy supply efficiency.
Reduce environmental effects and restore competitive economic growths.
Impact the efficiency and ensure competitive future of wind energy plants.
Affect state wise renewable energy generation capacity through enclosed wind energy plants.

By comparism, conventional wind turbines are:
Are exposable
Are affected by natural wind flow
Are affected by environmental conditions
Destroy environmental habitants
Occupy more uncontrollable spaces
Are costly to maintain
Provide geological congestion
Obstruct historical views
Affect environmental and city needs
Are exposed to turbulence

In a wind and power apparatus, a wind power without wind “WPWW” is disclosed. The wind is generated and the wind force is gathered by an apparatus such as, for example, blades of turbines, causing these blades to rotate, creating “mechanical energy.” The mechanical wind energy is converted into different forms of energy, such as, for example, electrical energy. Embodiments provide a wind power apparatus that comprises of, or is associated with a generator assembly for converting mechanical energy into electrical energy. What this technology brings include:
Provides controllable energy supply to meet existing and projected demands.
Replaces time lost to environmental effect and relieve no naturally occurring wind conditions on land.
Enhances wind reliability and renewable electrical energy supply.
Reduces environmental effects and restores competitive economic growths.
Impacts energy efficiency and ensures competitive future of wind energy plants.
Positively affects state wise renewable energy generating capacity.

Some embodiments of the disclosure further relate to the awareness of producing abundance of energies without affecting the environment. Certain embodiments provide methods and systems that teach the importance of harvesting these energies for the production of renewable electrical energy without massive consumption of other energies, such as water and/or fuel. Still, some embodiments further include the application of enclosing wind turbine assembly within a building structure and generating a controllable wind to propel the turbine blades for the turbine assembly, producing renewable electrical energy. Yet other aspect of embodiments would educate the public about the importance of these teachings, which include regenerative dams responsive to concentrated hydropower. Some of the negative consequences of constructed dams can be eliminated through the understanding of the application of disclosed embodiments. The potential loss of wind and water flow and the natural environment that may be destroyed or diminished from the diversion of wind and water from its natural path to the hydro-generating stations of conventional wind and hydropower plant is eliminated. The massive water consumptions of other power plants such as nuclear power plant, parabolic solar plant, and coal fired plant can be eliminated with the implementation of disclosed embodiments.

Furthermore, exposable wind energy doesn't really reduce pollution completely at 100% when the wind is not available because other fossil-fired generating units would be running on a temporal basis until the wind is available again. Ice throw may occur with the conventional exposable wind turbine, and because ice buildup slows a turbine's rotation though being sensed by a turbine's control system, the buildup would still cause the turbine to shut down, thereby turning the fossil power plant on and adding more pollutant into the environment. The blades of conventional exposable turbine farms create lots of turbulences which can mix air up and down and create warming and drying effect near the ground. The rotating blades of conventional exposable wind mill could redirect high-speed winds down to the earth's surface, boosting evaporation of soil moisture. Land transportation represents yet another potential limiting factor for wind turbine growth.

Developing wind farms on mountains that are already being used for ski resorts are not the idle solutions because these mountains are touristic sites. Exposable wind turbines, such as those typically installed at conventional wind farms, can interfere with radio or TV signals if the turbines are in the line of sight, say between a receiver and the signal source. Also, conventional wind farms interfere with radar signals because radar basically are designed to filter out stationary objects and display moving ones, and the moving wind turbine blades can create radar echoes. The embodiments provide enclosed turbine power plant to further eliminate these problems. Conventional exposable wind farm further interferes with environmental safety and modifying existing apparatus to compensate for the existence of conventional exposable wind farm would dictate cost and reduce technological advancements. Exposable wind farm near airports or military airfields would create further issues that are being eliminated in disclosed embodiments. Though it is visual that we have to move away from conventional fossil fuels like coal and oil and look at alternatives, energy sources, conventional exposable wind farms still have unaddressed environmental issues which are being addressed in disclosed embodiments.

Additionally, conventional hydropower plants utilize embankments which usually are built to reserve water and create differences in water levels. Lakes in high altitudes are costly and also used for the same purposes (the storage of potential energy within the water as the “fuel” for power generation). Five factors are usually used to determine the kind of dam to be built, this include:
the height of water to be stored,
the shape and size of the valley,
the geology of the valley walls and floor,
the availability, quality and cost of construction materials, and
The availability and cost of labor and machinery.

Conventional power stations contain turbines and generators usually built near the downstream side of the dam. With the conventional dams, pipes or channels are used to direct water from the storage to the stations. Within the station, water pushes the turbine that generates electrical energy and then exits through the tailrace. These processes have existed for long and new researches are needed for the development of power plants that are cost effective. Although current conventional Wind and Hydropower plants have many advantages, there are still quite a few setbacks. The increase of water level could destroy the habitat for humans and other species by flooding of lands. Additionally, flooding also causes soil erosion on the watershed's wall. This could impact the vegetation of the area. Along with the disruption of natural orders, flooding also could threaten historical landmarks found alongside the river systems. Moreover, building a hydro dam proximate to any city is a potential time bomb for that city if located downstream. Historically, conventional hydropower plants impact water quality and may cause low dissolved oxygen levels in the water. With current conventional hydropower plants, maintaining minimum flow of water downstream are critical for the survival of riparian habitats. Electricity from these plants could not be produced when the water is unavailable. Additionally, humans, flora, and fauna may lose their natural habitats.

In addition, there are costs and considerations associated with constructing conventional hydro electric dam, this include:
6. A dammed river, which means that a valley must be flooded. This may have an effect on erosion and may cause loss of habitat to local wildlife. Farmland may also be lost.
7. Special slipways for Hydro electric dams to prevent fish from being swept into the works
8. In areas with unreliable rainfall for obvious reasons.
9. A lot of energy needs to go into the construction of the dam and turbines.
10. Directing a lot of expensive energy into the construction of Dams.

However, conventional wind and hydropower also have some benefits for the environment and for the people, such as:
The wind and water is a safe habitat for aquatic life and for wading birds
The dam also provides a source of wind and water for wildlife and farm animals in the surrounding area.
The artificial lake created by the dam has some tourism spin-offs for the local community—boating and fishing in particular (sometimes, the outflow wind and waters from the dam are warmer and fish thrive in them—The lakes can also be used for fish farms.
The power generated by this means is very clean and produce no carbon emissions.

Overall, these are effective mediums for producing renewable energy, but due to the reasons discussed above, such as the social, economic and environmental costs, it may be feasible for use in some towns and unfeasible for use in other towns. Disclosed embodiments can supplement the conventional wind and hydropower plant.

### SUMMARY OF THE INVENTION

For many decades, constant emission of greenhouse gases has exceeded the atmosphere's capacity to safely absorb them. These have resulted in climate crises which must be solved now, and getting the right solution for the climate crises problems require a technological breakthrough that presents a cleaner and environmentally friendly solution. The electrical energy should be storable and transportable. However, according to The Department of Energy, the energy challenges our country faces are severe and have gone unaddressed for far too long.

The severity of the challenges has been experienced with the conventional electrical energy plants. Conventional electrical energy plants have their pitfalls. For example, using coal for electrification is not infinite and can only provide temporal relief from the world's long term electrification problems. Additionally, the combustion of coal, though cleaner, generates carbon dioxides (Greenhouse gas) sulfur oxides, nitrogen oxides, and mercury compounds. Although emission control devices mitigate the air pollution when properly employed in the United States, other countries have failed to use these devices. Therefore there is a long lasting scar on landscape from coal mining and these can result in runoff of toxic substances such as lead, mercury, and arsenic. Also, the water used in the boiler of a coal fired power plant accumulates pollutants and when the water is replaced, the pollutants must be safely disposed of, which increases the cost of operation.

In the near future we will launch a plan for replacing oil with solar energy for routine travel without resorting to tragedy of trashing our soils and water reserves for the sake of hopeless inadequate bio fuels production. [Al Gore, Jul. 17, 2008]

The production of biogas by composition can produce objectionable odors. Regarding methane for electrification is good. However, any leakage into the air would result into explosive. Price spike and supply disruptions have marred its reliability. Methane is also finite and nonrenewable. The exploration for natural gas and its recovery process can adversely impact the environment by causing erosion, accelerating runoff, and increasing mudslide and flood risk.

Disclosed embodiments provide enclosed wind turbine plant having one or more wind turbine. The wind turbine is associated with a variable speed control system. The control system is further associated with a fluid force control system operable to initiate initial rotational speed set point. At least one sensor is disposed for communicating turbine operational parameters. The control system is selectively configured for communication with the turbines and/or the fluid force generation apparatus to enable adjusting the rotational speed set point greater than the initial rotational speed set point in response to the operational parameters of the fluid force generation apparatus. The wind turbine plant further includes a central monitoring station configured for use on a mobile plant and/or a stationary plant. The central monitoring station is configured to selectively permit viewing of the wind turbine operation and for making adjustment of the control system in response to an external requirement. Embodiment provides the fluid force generation apparatus further comprises compressed air apparatus operable for controlling atmospheric pressure into an enclosed environment, compressing the atmospheric pressure to enable a compressed air within the enclosed environment. The turbine blades responsive to the pressure from the compressed air and the compressed air being released back to atmospheric pressure through an exit channel.

WPWW provides advanced methods and systems to maximize net impact on wind turbine operations and to reduce the overall cost of producing renewable energy through performance enhancement and reliability. The advanced methods and systems further comprise an effective environment for turbine assembly monitoring, maintenance, refurbishment, and replacement. WPWW further provides easy and cost effective methods of recycling inspection procedures. WPWW provides wind turbine plant application method that is appropriate for operation as unique solutions to the ongoing wind energy problems. WPWW further provides methods and systems of operation that enhances economic viability and predictive turbine assembly operating conditions and monitoring. WPWW is a system for reducing unscheduled outages, for monitoring failures, for scheduling maintenance needs before problems occur, and for withstanding extreme environments and environmental conditions, such as high temperatures, high humidity, extreme cold, corrosive offshore environments, high speed wind and dust. Constant emission of greenhouse gases has exceeded the atmosphere's capacity to safely absorb them and getting the right energy solution requires a technological breakthrough that is cleaner and environmentally friendly. WPWW is environmentally friendly and our prototype model is transportable, mobile, and will produce clean energy on demand. The prototype model is operable in the bedroom, garage, camps, living room, in the trunk of a car, in a boat, or even at the backyard.

Disclosed embodiments are further required for States with constant environmental emergencies. Embodiments provide transportable renewable energies. Disclosed embodiments present a new educational literature for producing energies on demand to add to the number of other existing programs. Embodiments teach ways to expedite the supply of renewable energy to reduce U.S dependence on foreign oil. Investment in wind and hydropower technology for disclosed embodiments worth building a plant to facilitate the process. The wind and hydropower plant would enable the study and installation of emergency transmission lines “Smart Lines” in all residential, industrial, and other construction areas.

Wind and Hydropower plant, in certain embodiments, include the generation of electrical energy through enclosed wind and water pressure. Embodiments further provide apparatus, which relates to wind and hydropower plant for generating transportable energy and for generating energy on demand. Some of disclosed embodiments further relate to wind and hydropower plant comprising enclosed turbine assemblies, exposable turbines and/or submersible turbine configuration, all incorporated in disclosed embodiments to provide apparatus for producing renewable electrical energy that can be stored and/or be transmitted on demand.

Conventional hydropower plants comprises of wicket gate mechanism, turbine governors, generator bearings, and lube oil system that usually force outage or force scheduled maintenance outage. Maintenance for these conventional plants further requires de-rating of hydroelectric turbines. The propulsion of random flow pressure on conventional hydropower plants is ineffective because controlling pressure rate of water for such malfunctioned dam could be catastrophe. Other conventional methodological power plants are not environmentally conducive because most require substantial amount of water consumption in other to produce electrical energy. For example, according to U.S. Department of Energy, a coal fired plant uses 110 to 300 gallons of water per megawatt hour; a nuclear plant uses between 500 and 1100 gallons/MWh; and a solar parabolic trough plant uses 760-920 gallons/MWh. These are waters that could benefit consumer supply chain and U, S medical and pharmaceutical industries. Disclosed embodiments address issue of water through concentrated pump pressured hydropower facility. The concentrated hydropower plant is an important innovation for solving the inherent scares of the habitants. Disclosed embodiments further provide apparatus for utilizing unpressured water to generate the needed pressure to generate the required electrical energy at particular periods. Disclosed embodiments further provide means for generating electrical power for industrial and commercial applications.

Further benefits of WPWW include:
Creates no pollution
Creates no greenhouse gas
Produces electrical energy at much lower cost
Energy is independently produced without the effect of natural wind flow and environmental condition
Energy is cleaner and regenerative
Production method would contribute to national security
Production method would contribute to improved environmental quality
Production method would stimulates economic development
Would not destroy environmental habitats
Would not cause harm to the inhabitants
Production method is less saturating
Production method is operable in confined spaces
Production method would prevent geological congestions
Production method would eliminate historical view obstructions
Production method would protect environmental and city needs
Production method is protected against turbulences
Production method is protected against extreme wind conditions
Production method would strengthen market capacity for sustained commercial operation of industrial/domestic energy enterprise
Production method is a climate-friendly solutions for meeting industrial/domestic energy needs
Production method is committed to sustainable market development.

### BRIEF DESCRIPTION OF THE DRAWINGS

FIG. 1 is seen exemplary embodiments showing sections of a building structure 20 configured with device for generating operating wind.

FIG. 2 is seen embodiments of wind generating apparatus 100 disposed on the building structure 20 for operating the enclosed turbine assembly 200.

FIG. 3 is seen exemplary embodiments of the building structure 20 configured with apparatus comprising wind entrance 4 and exit ports

FIG. 4 is seen further exemplary embodiments of the building structure 20, multiple devices for generating operating wind, and the wind turbine assembly 200.

FIG. 5 is seen exemplary embodiments of a dam 600.

FIG. 6 is seen similar exemplary embodiments of the wind and hydropower plant 12.

FIG. 7 is seen further exemplary embodiments of the enclosed wind energy plant configured with solar power and wind energy generators for the wind and hydropower plant.

FIG. 8 is seen further exemplary embodiments of the solar power and wind energy generators for the enclosed turbine assembly.

FIG. 9 is seen further exemplary embodiments of the wind and hydropower plant disclosed with tunnel being configured with turbine assembly.

FIG. 10 seen further exemplary embodiments of the ventilation apparatus, the building structure, and the hydropower apparatus for the wind and hydropower plant.

FIG. 11 is seen further exemplary embodiments of the building structure and the turbine operation.

FIG. 12 is seen further exemplary embodiments of the wind and hydropower plant configured with tunnels and hydropower pipes.

FIG. 13 is seen exemplary embodiments of nanotechnology application comprising substrate-microfiber 724.

FIG. 14 is seen exemplary embodiments of energy medium.

FIG. 15 is seen further exemplary embodiments of the energy medium comprising energy storage apparatus 720.

FIG. 16 is seen further exemplary embodiments of the energy medium.

Referring to FIG. 17 is seen exemplary embodiments of a charge transport comprising microfiber material 710 being configured with silicon substrate 71

Referring to FIG. 18 is seen an exemplary embodiment of a pneumatic component of the turbine generator assembly.

Referring to FIG. 19 is seen an exemplary embodiment of a setup for the pneumatic component and the turbine generator assembly.

Referring to FIG. 20 is seen further exemplary embodiment of the pneumatic component of the turbine assembly.

Referring to FIG. 21 is seen further exemplary embodiments of turbine assemblies being disposed inside a building structure 20, comprising an enclosed environment for wind turbine plant operation.

Referring to FIG. 22 is seen further exemplary embodiment of the wind turbine plant operation comprising pneumatic component of the turbine generator assembly.

Referring to FIG. 23 is seen further exemplary embodiment of the pneumatic component of the turbine generator assembly.

Referring to FIG. 24 is seen an exemplary embodiment of a pneumatic configuration for an enclosed wind turbine operations.

Referring to FIG. 25 is seen further exemplary embodiment of the enclosed wind turbine system being configured for pneumatic power operations.

Referring to FIG. 26 is seen further exemplary embodiments of the wind generation apparatus being configured with a pneumatic apparatus for operation within a building structure.

### DETAILED DESCRIPTION OF THE INVENTION

Embodiments include apparatus for an enclosed wind and hydropower plant configured for converting generated wind and kinetic energies into renewable electrical energy. Some embodiments described below relates to enclosed turbine assembly, solar energy, and hydropower. For example, in some embodiments, the apparatus as described comprises a power plant. In some embodiments, the apparatus as described comprises wind flow apparatus comprising a ventilation platform array. In certain embodiments, the apparatus as described comprises a fixed ventilation platform array. In other embodiments, the apparatus as described comprises a horizontal ventilation platform array. Still in some embodiments, the apparatus as described comprises a vertical ventilation platform array. Yet in other embodiment, the apparatus as described comprises an angular ventilation platform array. In some embodiments, the apparatus as described is a wind mill plant. In some embodiments, the apparatus as described is a hydropower plant. Still in certain embodiments, the apparatus as described is operatively configured with at least a solar power apparatus.

Yet, disclosed embodiments further provide ventilation platforms comprising compressed air apparatus operable for controlling atmospheric pressure into an enclosed environment, compressing the atmospheric pressure to enable a compressed air within the enclosed environment. The turbine blades responsive to the pressure from the compressed air, and the compressed air being released back to atmospheric pressure through an exit channel. Certain embodiments provide the ventilation platform comprising an entrance channel having a bigger cross sectional area than the exit channel. Some embodiments provide the exit channel being affixed with at least an accelerator apparatus operable for releasing the compressed air back to the atmosphere. Still in other embodiments, the accelerator is operable for converting the compressed air back to atmospheric pressure. The accelerator is seen throughout the drawing as an exit channel.

The terminology used herein is for the purpose of describing particular embodiments only and is not intended to be limiting of embodiments. As used herein, the singular forms “a”, “an”, “at least”, “each”, “one of” and “the” are intended to include the plural forms as well, unless the context clearly indicates otherwise.

It would be further understood that the terms “include”, “includes” and/or “including”, where used in this specification, specify the presence of stated features, integers, steps, operations, elements, and/or components, but do not preclude the presence or addition of one or more other features, integers, steps, operations, elements, components, and/or groups thereof. In describing example embodiments as illustrated in the drawings, specific terminology is employed for the sake of clarity. However, the disclosure of this patent specification is not intended to be limited to the specific terminology so selected and it is to be understood that each specific element includes all technical equivalents that operate and/or function in a similar manner. It would be further noted that some embodiments of the enclosed wind and hydropower plant is used concomitantly and/or not used concomitantly with solar power. This is rather than using the solar power reflection for initial operating energy. In some embodiments, the enclosed wind and hydropower plant comprises a platform array responsive to solar energy. In some embodiments, the enclosed wind and hydropower plant further comprise of a platform array responsive to solar energy radiation. Other embodiments herein describe apparatus configured for producing renewable electrical energy.

The foregoing and/or other objects and advantages would appear from the description to follow. Reference is made to the accompanying drawing, which forms a part hereof, and in which is shown by way of illustration specific embodiments in which the embodiments may be practiced. These embodiments being described in sufficient detail to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims.

Referencing the drawings, wherein reference numerals designate identical or corresponding parts throughout the several views, example embodiments of the present patent application are hereafter described. The numbers refer to elements of some embodiments of the disclosure throughout. As used herein, the terms “and/or” and “at least one of” include any and all combinations of one or more of the associated listed items.

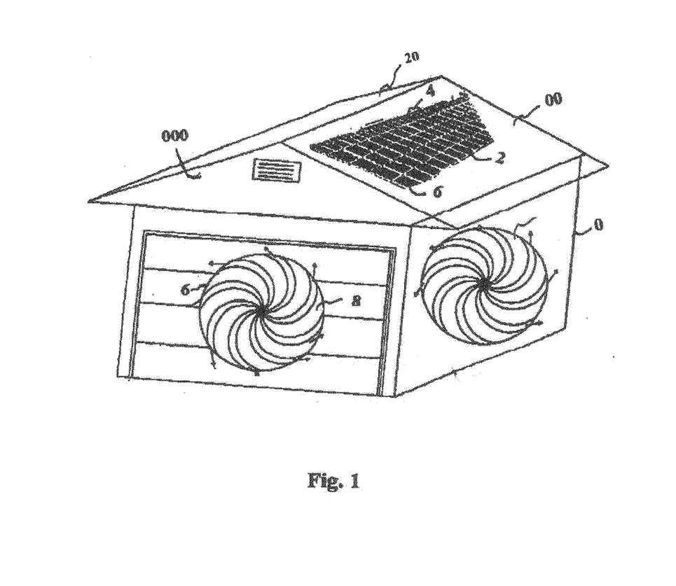

Referring to FIG. 1 is seen an exemplary embodiment of a building structure 20, comprising a vertical member 0, a horizontal member 00, and an angular member 000. The vertical members 0 further comprises of the side walls of the building structure 20. The horizontal members 00 further comprises of the top roof and the floor of the building structure 20. The angular members 000 further comprises of both the vertical and the horizontal members and/or both taken in any combinations to derive a configuration that is angular in structure. A wind generating device is disposed at the roof. The wind generation device further comprises compressed air apparatus operable for controlling atmospheric pressure into an enclosed environment, compressing the atmospheric pressure to enable a compressed air within the enclosed environment. The turbine blades responsive to the pressure from the compressed air, and the compressed air being released back to atmospheric pressure through an exit channel. An exemplary embodiment of the wind generating device further comprises a ventilation apparatus 100, being configured for accelerating the inflow of wind into the interior 113 of the building structure 20. Certain embodiment provides a wind generation device comprising apparatus for pulling atmospheric pressure into the building structure. Each member 0, 00, 000, further comprises an exemplary embodiment of at least an opening 2 and 6, each configured for the fluid entrance 4 channel, and/or for fluid exit 8 channel. At least one exemplary embodiment of the fluid comprises at least one of wind; air; compressed air; water; liquid solution; and/or any combination thereof. The fluid exit channel further comprises an accelerator being operable for accelerating the compressed air for conversion back to atmospheric pressure.

An objective of disclosed embodiments is to reduce the cost of energy so that wind turbine applications would compete with conventional/traditional energy sources, providing a clean, renewable alternative for nation's energy needs while strengthening national economic security. Further objective of disclosed embodiments comprises cost-effective, high performance wind turbine technology that would compete in global energy markets. Embodiments provide innovative methods and design to refine advanced wind turbine plants. Certain embodiments provide an exemplary embodiment for generating renewable energy, comprising providing a system source which is steady, most reliable, and affordable. Some embodiments provide the most cost-efficient unconventional energy source for the market, addressing the growing demand for green electricity production worldwide.

With the disclosed embodiments, turbine cost would drop and would lead to increased supply of green electrical energy production to enable electricity supply to the grid. Disclosed embodiments provide methods and systems to expedite renewable energy generation through the application of at least one of: enclosed wind turbine operations, compressed air for turbine operation, pneumatic turbine system operation, and/or any combination thereof. Disclosed embodiments further address technological challenges arising from wind turbine designers and wide range of technical responses, machine configuration, operational parameters, controls, and power conversion techniques. Embodiments provide apparatus for generating operating wind for the enclosed wind turbine assembly to enable turbine operation, generating mechanical energy, and converting the mechanical torque into electrical energy. Embodiments provide an exemplary configuration for the enclosed wind power plant, operable to generate fluid flow pressure to propel the wind turbine blades, and effectively extracting power from the wind turbines, while expanding the lifespan of the plant by making the wind turbines cost effective.

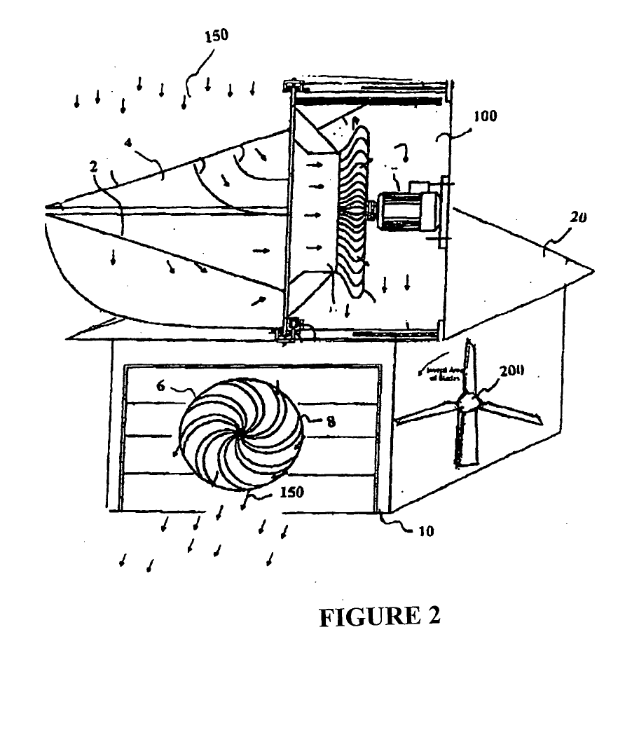

Referring to FIG. 2 is seen an exemplary embodiments of the enclosed wind turbine plant 10. Disclosed embodiments is further configured to yield economic gains and to provide energy security. Disclosed embodiments further provide apparatus and/or methods of installation of at least a turbine assembly 200 inside a building 20 and providing means to generate renewable electrical energy. Embodiments further provide at least a method for supplying propellant-fluid/wind 150 to the building structure to enable the efficient operation of the turbine assembly 200. At least one method as disclosed herein comprises at least an apparatus configured for accelerating outside airflow/wind 150 into the building structure 20. The building structure 20 is further configured with at least an entrance channel 2, and at least an exit channel 8 for the airflow/wind 150, whereby fluid pressure force is created there-between to propel the blades of the turbine assembly 200.

Disclosed embodiments further provide innovative and cost effective methods and systems for improving renewable energy production efficiency at a larger scale. Certain embodiments provide the wind turbines being further operable as renewable energy plants to compete with conventional energy plants. In the disclosed embodiments, the plant is further provided to gain more secured energy independence. Certain embodiments of the disclosure comprise at least a ventilation apparatus 100, a wind generation apparatus in communication with at least a turbine assembly 200. The wind generation apparatus is affixed in the building structure 20, and in fluid communication with the turbine assembly 200. The building structure 20 is further disposed with a control device to enable at least a controllable opening 2 at the top 4, and at least a controllable opening 6 at the side 8 through which wind enters and leaves the building structure 20. The enclosed wind turbine plant further comprises a wind and hydropower plant 10 further configured with apparatus for producing renewable electric energy without consumption of fuel oil resources. Yet, other embodiments of the disclosure comprise an enclosed wind and hydropower plant 10 that is operable to create no pollution or greenhouse gas emission, and is independent of ocean pressure and/or does not depend on the natural existence of wind.

Embodiments provide apparatus for extracting the proportionate amount of fluid pressure and for directing a controllable amount of the fluid to operate the enclosed wind turbines. Further embodiments of the disclosure provide apparatus being configured to adjust to operational thermal conditions of the building structure, enabling a suitable environment for the efficient operation of the enclosed turbine assemblies for the wind and hydropower plant. Embodiments further provide devices for generating wind even when there is no wind to the external environment of the plant. The enclosed wind and hydropower plant further comprises a wind turbine plant being configured to generate electricity by converting the kinetic energy of the extracted wind into mechanical energy.

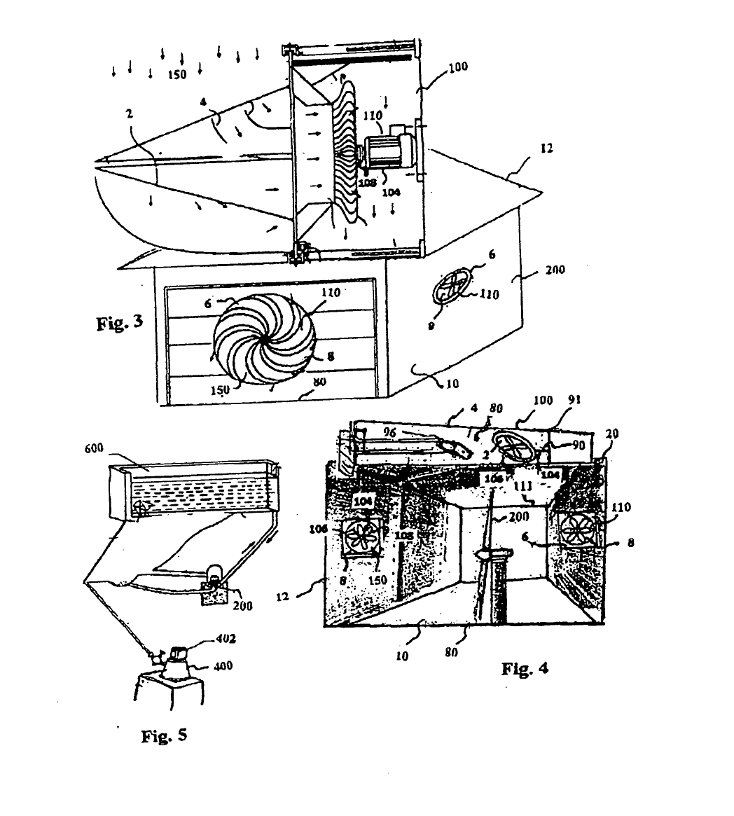

Referring to FIG. 3 is seen an exemplary embodiments of the wind and hydropower plant 12. Disclosed embodiments would produce electrical energy at a lower cost. Disclosed embodiments generates cleaner wind to operate a hydropower plant 12, comprising a domestically produced renewable energy resource that can contribute to nation's security, improve environmental quality, and stimulates economic development without destroying the environmental habitats. Disclosed embodiments can be incorporated in existing warehouses that can be easily transformed into a power plant, and may be installed using any method disclosed through these exemplary embodied methods without any additional aids provided. Disclosed embodiments further include one or more ventilation apparatus 100 operatively configured with fans 110 for generating wind power to operate the turbine assemblies 200 inside the building structure 20. The building structure 20 further comprises an enclosed environment for the enclosed wind turbine assemblies 200 to operate a wind energy power plant 12. The wind energy power plant 12 is configured for generating renewable electrical energy even without the existence of conventional wind energy methods.

Disclosed embodiments comprise fluid pressure generation apparatus that may include a ventilation apparatus 100 for generating air/wind 150 even without a conventional wind flow. The ventilation apparatus 100 further comprises compressed air apparatus operable for controlling atmospheric pressure into an enclosed environment, compressing the atmospheric pressure to enable a compressed air within the enclosed environment. The turbine blades responsive to the pressure from the compressed air, and the compressed air being released back to atmospheric pressure through an exit channel. Disclosed embodiments provide patterns for openings to enable air/wind 150 passages. At least one pattern is an entrance channel. At least another pattern is an exit channel. Embodiments further comprise at least a fan assembly 110 disposed on the top 4 of the building structure 20. Wherein the building structure further constituting an angular member, a vertical member, a horizontal member, each member, and/or any combination thereof comprising an entrance channel and/or an exit channel. Certain embodiments provide the wind generation apparatus being affixed on the building structure 20. At least one affixation further comprises at least one member further comprising the wall constituting the side exit channel 8 of the building 20. The fan assembly 110 further comprises a system for moving ambient outside air/wind 150 into a wind energy plant 12 or similar storage area to deliver wind and hydropower that is needed for the operation of advanced wind and hydropower plant 10, constituting an enclosed energy plant.

Disclosed embodiments further provide advanced wind turbine technology being configured with means to enable turbine rotation to generate renewable electrical energy. The means further addresses environmental impacts, such as erosions, the killing of births and bats due to collision with the turbine blades. Visual impact can be eliminated with disclosed embodiments. Shadow flicker and touristic views can be eliminated with disclosed embodiments. There is current opposition to exposable wind farms because of the arising perception that the further development of these farms would spoil the view that habitants are used to. Wind farm applications can experience significant change with the application of disclosed embodiments.

The effect of renewable energy efficiency would be symbols of a better, less polluted energy future resulting from disclosed embodiments. Although the visual effect of wind farms is a historic subjective issue, the criticisms made about exposable wind energy today are vital and requires advanced technologies to enable improved solutions to credit wind mill technology applications without further creating any worries to local communities.

Referring to FIG. 4 is seen an exemplary embodiment of the building structure 20. Disclosure embodiments provide fluid pressure force generation apparatus that may include aventilation apparatus 100, operatively configured with at least one electrically driven fan assembly 110 installed on the upper part of a building 20 and/or at the door 80 of the building 20. A control means 96 is communicatively connected to at least one fan assembly 110. Certain embodiments further provide the fan assembly further comprising a motor 104 and a fan 108. The fan 108 is connected to the motor 104 through at least a shaft 106. A power cord 90 can be extended from the at least one fan assembly 110 to a fixed source of power 111 to enable rotation even without a belt connection. The fixed source of power 111 can be from at least a renewable energy source for supplying at least the initial operating energy for the plants' ventilation apparatus 100. The operation of the turbine assembly 200 is responsive to the wind power being generated by the ventilation apparatus 100. The turbine assembly 200 is configured to covert the wind power into mechanical energy. Disclosed embodiments provide method and systems for an enclosed wind power plant to generate wind power to effectively empower the wind turbine assembly 200.

Disclosed embodiments provide innovative methods and systems, and can expand the lifespan of wind turbines. Certain embodiments provide a fluid pressure force generation apparatus operable to enable wind turbine applications more cost effective. Some embodiments provide a force-exerting spring means 91 being operable for exerting continuous tension force on the power cord 90. The power cord is affixed within the building structure in association with the location of the fixed source of electrical power 111 to keep the power cord 90 sufficiently taut by exertion of the tension force so that the power cord 90 has substantially no slack. The initial power source 111 comprises at least one of: a battery means, a solar power 700, or a secondary wind turbine assembly. The spring means 91 for the power cord 90 is configured for eliminating substantially all of the slack in the power cord and does not form any intermediate loop or loops when the wind energy plant door 80 is being opened or being closed, keeping the power cord 90 safe from accidental harm as well as keeping it from becoming a hazard for the wind energy plant door 80.

The Wind and Hydropower plant, in some embodiments, relates to enclosed fluid pressure generation apparatus and wind turbine apparatus, simultaneously operable for generating abundance of renewable energy without creating any environmental impact. Disclosed embodiments provide environmentally friendly methods. Further embodiments of the disclosure comprise a plant, a mobile energy generation device, and/or a portable energy generation device that creates no pollution in the air, and that generates no chemical. The wind and hydropower plan further comprises a device for extracting proportionate amount of the environmental atmospheric pressure into the enclosed space of the building structure 20, allowing the pressure to build up inside the building structure 20, and exiting out through the exit channel 8. Certain embodiments provide a method of creating a pressure differential between the entrance channel and the exit channel to generate a flow pressure force to enable turbine blade rotation. Some embodiments further provide means for operating a wind turbine plant to generate electrical energy even when there is no existence of conventional wind.

Disclosed embodiments provide methods for generating controllable fluid pressure force into the enclosed space when there is no environmental pressure. The device further includes a ventilation apparatus configured for generating wind by pulling atmospheric pressure into the building structure through an entrance channel to an exit channel to enable wind flow for the operation of a turbine assembly. Disclosed embodiments further provide apparatus comprising at least high pressure water pump for generating pressurized water flow for the hydropower plant. The wind and hydropower plant is configured for generating renewable electrical energy. The plant is configured to produce reliable domestic/industrial energy and relies on the controlled air through a channeled conduit in association with the ventilation apparatus and/or the pumped water from the high pressure water pump to generate renewable electrical energy.

Embodiments further provide apparatus for producing renewable electrical energy on demand through a continuous controllable water and/or wind flow. Certain embodiments of the disclosure comprise enhanced energy transmission infrastructure for increasing renewable energy capacity through enclosed wind turbine applications. The application of disclosed embodiments would not be subjected to massive land requirements because the embodiments are streamlined for a contained environmental friendly infrastructure to enhance reliability and operability of the enclosed wind plant. Some embodiments of the disclosure further comprise advanced development for wind turbine applications to speed the commercialization of wind energy operation as a reliable infrastructure for national resource of renewable energy. Certain embodiments provide a pneumatic wind turbine system, an enclosed wind turbine plant, a channel flow wind turbine system, a regenerative wind turbine system, a compressed air wind turbine system, and/or any combination thereof comprising advanced methods to maximize net impact on wind turbine applications and to reduce the overall cost of producing renewable energy through performance enhancement and reliability. The advanced methods further comprising means for improving maintenance, refurbishment, replacement, and recycling inspection procedures. The means further comprising an easier and cost effective approach to wind turbine operation. Some embodiments provide methods for wind plant application that is appropriate for wind plant operation as a unique solution to ongoing wind energy problems.

Further objective of disclosed embodiments comprise improved and reliable methods for operating wind plants. Other objectives of disclosed embodiments comprise method of operating a wind plan with enhanced economic viability and predictive turbine assembly condition monitoring. Further aspects of the predictive monitoring include blades, gearboxes, towers, and generators. Yet, some disclosed embodiments provide at least an exemplary model for predicting real-time performance and for monitoring component failure. Still, certain objectives of disclosed embodiments comprise systems for reducing unscheduled outages and advanced systems for monitoring failures and scheduling maintenance needs before problems occur. Yet some embodiments of the disclosure provide an environment and/or methods for withstanding extreme environments and environmental conditions, such as high temperatures, high humidity, extreme cold, corrosive offshore environments, high speed wind and dust. Yet, certain objective of disclosed embodiments provides methods for integrating wind turbine applications into total controllable wind for wind turbine plant applications.

Referring to FIG. 5 is seen an exemplary embodiment of a dam 600. Certain embodiments provide a hydropower device comprising regenerative dam 600. Disclosed embodiments provide the regenerative dam 600 being pump operated. Disclosed embodiments comprise at least a mechanical pump 400 operatively configured to provide fluid flow for the operation of a turbine assembly 200. Embodiments provide methods and systems to overcome environmental issues. Disclosed embodiments further provide methods and systems for providing fluid pressure force for enclosed wind and hydropower plant configured for generating low cost electric power without any consumption of fuel oil resources and/or creating pollution, or any greenhouse gas emission. Certain embodiments of the disclosure include wind and hydropower plant 10 being independently operable of wind pressure, water pressure, and/or a combination of both wind and water pressure conditions. Disclosed embodiments include at least a pump assembly 402, which may be positioned at the top of one or more stacks of fluid or fluid passages for generating fluid pressure to propel a turbine assembly for a hydropower plant, and for increasing flow rate for at least controllable intervals.

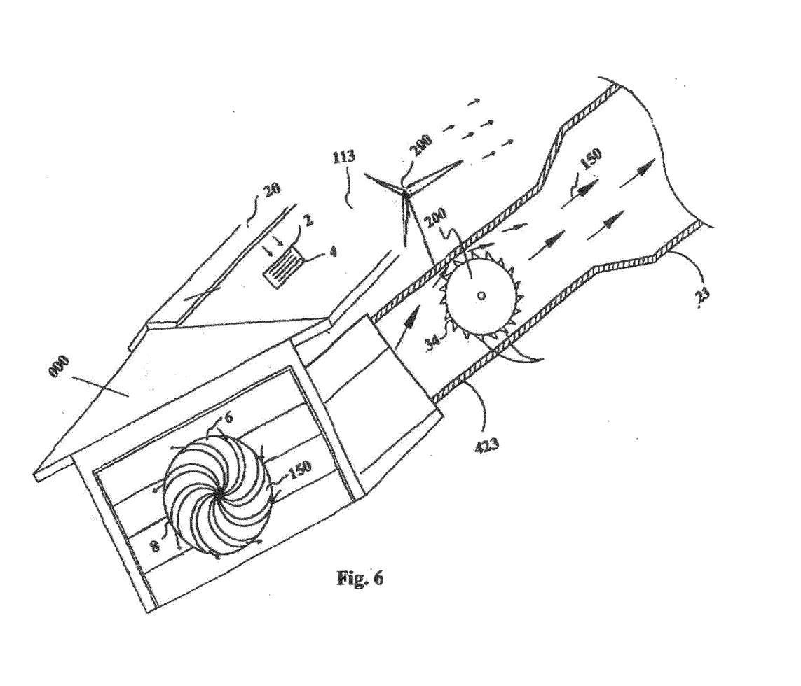

Referring to FIG. 6 is seen similar exemplary embodiments of the wind and hydropower plant 12. More particularly, disclosed embodiments further comprise a tunnel 23 operatively configured for flow-force passage/application. Embodiments provide fluid comprising, for example, air/wind 150 and/or water, which could be directed through a tunnel 23. The wind energy plant 12 comprises turbine assemblies 200 being responsive to the fluid flow pressure. Embodiments provide the fluid flow pressure generation at a controllable temperature. Embodiments further provide apparatus for accelerating the cooler outside air into the tunnel, which is affixed inside the wind energy plant for generating renewable electrical energy. Disclosed embodiments, provide renewable energy generation apparatus comprising accelerating cooler outside air/wind 150 into the building structure to cause the operation of the turbine assembly 200.

Certain embodiments provide renewable electrical energy generation methods by means of fluid flow pressure inside the tunnel 23. The means further comprises water pressure 423 operable for rotating a wheel/blade 34 to generate mechanical energy. The mechanical energy is then converted into electrical energy by the turbine assembly. Disclosed embodiments further provide methods and systems being configured to cause the hotter air to be forced out of the wind energy plant interior 113 through the exit channels 8, enabling a pressure differential to propel the blades of the turbine assemblies. Certain embodiments of the disclosure comprise pushing the hot air out of the wind energy plant 12, and pulling the cooler ambient outside air/wind 150 in to propel the turbine assemblies 200. Disclosed embodiments further provide methods and systems of operation that is reversible depending on the environmental condition. Yet, embodiments provide a method of generating electrical energy by pulling in atmospheric pressure, filtering out the humidity to cool down the temperature, while generating renewable electrical energy in the process.

Disclosed embodiments comprise an enclosed wind plan method of using a ventilation apparatus 100 to provide wind 150 for the operation of a turbine assembly 200. Disclosed embodiments provide environmentally friendly methods and system that would not cause harm to the inhabitants. Embodiments further provide less saturating methods and system, operable in a confined space. Embodiments further provide a controllable wind and a controllable temperature conditions to enable efficient and effective methods of generating renewable electrical energy. Disclosed embodiments provide methods of preventing habitant destructions, generating seasonal wind, preventing geological congestions, preventing historical view obstructions, and providing environmental safety.

Disclosed embodiments further provide wind and hydropower plant comprising enclosing apparatus in a building structure operatively configured for communication with the turbine assembly, providing the necessary air/wind that is needed to propel the blade for the wind turbine assembly. A mechanical pump is further provided and operatively configured for providing hydropower to the hydropower section of the plant. The wind and hydropower plant is configured for producing renewable electrical energy without consumption of fuel oil resources.

Disclosed embodiments can produce renewable electrical energy without creating any pollution or generating any greenhouse gas. Disclosed embodiments further provide an unconventional wind plant application to protect against environmental conditions, such as environmental emergencies. Yet, disclosed embodiments provide renewable electrical energy that is cleaner, regenerative, and further provide cost effective methods of generating renewable electrical energy.

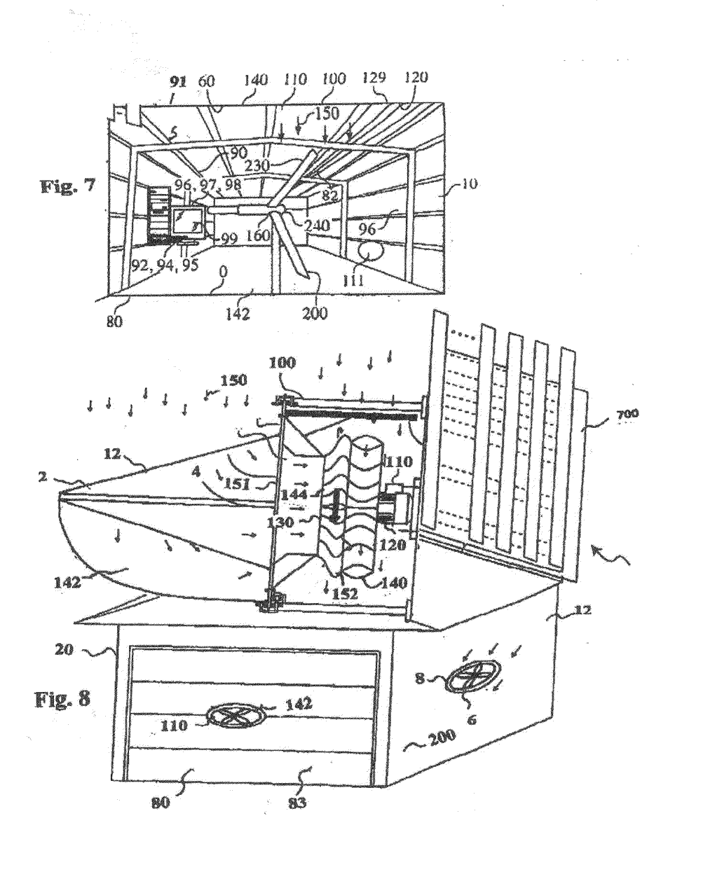

Referring to FIG. 7 is seen an exemplary embodiment of the disclosure. Certain embodiments provide methods of wind turbine applications in congested environmental and/or city conditions. In some embodiments, the disclosures provide methods to control the physical location of the part of the electrical power cord 90 that is extended from the fixed location of the electrical power source 00, 111 to the fan motor 120. Embodiments provide the fan motor 120 being configured for the operation of the ventilation apparatus 100. Disclosed embodiments comprise the motor 120, which can be disposed on the wind energy plant door 80. The door is associated with the building structure 20. In the later embodiments, the motor 120 can be moved with the wind energy plant door 80 without interfering with the opening position 82 or closing position 142. Embodiments provide a fan assembly 110 operatively connected to the motor 120. The fan assembly 110 and the motor 120 may be mounted on the wind energy plant door 80 and/or may be mounted at the top roof/ceiling 60 of the building structure 20. The power cord 90 is extended from a fixed connection with the power source 111 to the fan motor 120. Disclosed embodiments provide methods to eliminate the cord installation in the wind energy plant door 80 which may be hanging down or possibly being caught between two of the wind energy plant door hinged sections. The wind energy plant door 80 is configured for movement and for the operation of an exemplary embodiment of the ventilation apparatus 100. The ventilation apparatus 100 may be moved to the vertically-closed position and/or to the horizontally opened position.

Disclosed embodiments further provide energy generation method to improve environmental quality and to contribute to national security. Still, disclosed embodiments further provide energy generation method to stimulate economic development. Yet, disclosed embodiments provide energy generation method that would not destroy environmental habitats and would not cause any harm to the inhabitants. Still, disclosed embodiments further provide energy generation methods configured to provide a less saturating power plant. Yet, embodiments may be operable in a confined space to further prevent geological congestions. Certain disclosed embodiments provide energy generation system that would not obstruct structures that are designated as historical view. Yet, other disclosed embodiments wind energy generation methods to protect environmental and city needs. Still, some disclosed embodiments provide energy generation methods to prevent turbine assembly operations against turbulences. Other disclosed embodiments provide energy generation methods to protect turbine operations against extreme wind.

Embodiments provide methods for enabling large energy production for industrial and commercial applications through the use of concentrated dam and enclosed wind turbine assembly. Embodiments further provide effective concentrated dam and effective turbine assembly operation for energy production that utilizes less devoted amount of water used to produce the renewable electrical energy. Water is an important but overlooked issue of renewable energy devices, and may affect the world's demand of water. Disclosed embodiments provide apparatus for producing effective renewable energy.

Referring to FIG. 8 is seen further exemplary embodiment of the disclosure. Disclosed embodiments provide wind pressure force and energy generation apparatus operatively configured to produce electricity at cost effective rates in an environmentally friendly manner. Disclosed embodiments provide energy generation apparatus which is enclosed to enable enclosed wind energy plant applications. Embodiments further provide energy generation apparatus comprising methods and systems that further depart away from conventional wind energy plant applications. Disclosure of embodiments provides energy generation methods and systems for preventing plant operational environmental emergencies. Embodiments further provide energy generation methods and systems operatively configured to prevent the exposure of turbine operations against extreme wind velocity and turbulence. Certain disclosed embodiments provide turbine assembly 200, which is enclosed inside building structure 20. Some embodiments provide energy generation methods and systems that are configured for generating/directing wind into the building structure 20 to enable the turbine systems operation for electrical energy generation. Other embodiments further provide energy generation methods and systems comprising ventilation apparatus 100 in association with the enclosed wind energy plant 12. The energy generation methods and systems may enable installation achievement in a building structure 20 that is also located in heavily populated environment such as major cities.

Embodiments herein disclosed comprise a wind generation apparatus, such as, for example, a ventilation apparatus 100 operatively configured for supplying accelerated air/wind 150 for the operation of the turbine assembly 200 enclosed inside the wind energy plant 12. Multiple ventilation apparatus 100 are configured with air scoop assemblies 140 which are hoisted above a vertical/horizontal axis. Disclosed embodiments further provide energy generation systems that utilize the air scoop assembly 140 configured for directing the prevailing air/wind 150 and for utilizing the maximum airflow 150 to propel the turbine assembly 200 at the occurring maximum regenerative wind velocity head pressure to renewable electrical energy.

Certain embodiments provide the ventilation apparatus 100 comprising a motor 120 being configured to rotate a fan 110 to direct atmospheric pressure/airflow 150 into the building structure 20. The fan assembly 110 is configured to operate the air intake port 151. Some embodiments provide the air intake port being responsive to access door 144, being open to allow airflow 150. The air flow is directed downwardly in communication with the turbine assembly 200. Certain embodiments of the disclosure further provide energy generation apparatus in association with the opening 2, comprising the airflow entrance 4, and the opening 6 comprising the airflow exit 8. The airflow exit structure may be disposed at the walls or at the door 80. The velocity head pressure may enter the building structure 20 through the access door 144 and out through the exit structure 8. The pressure difference between the entrance 4 and the exit 8 determines the speed at which the turbine would operate. The airflow may be distributed uniformly and downwardly for operation of the turbine assembly 200. A solar power 700 is configured with the plant 12, to supply the initial operating energy for the initial operation of the ventilation apparatus 100. The solar power 700, further comprises solar cell comprising at least sensors embedded in a silicon substrate and fused/etched in a nano-fiber material. Some embodiments provide the solar cell further comprising non ferrous materials being embedded in substrate nano-fiber materials to enable nano structured solar cells.

Disclosed embodiments further comprise an enclosed wind and hydropower plant configured for producing renewable electrical energy without consumption of fuel oil resources. Some benefits of disclosed embodiments include:
d) Creates no pollution
e) Creates no greenhouse gas
f) Produces electrical energy at lower cost
1. According to embodiments, energy is independent produced without the effect of natural wind flow and environmental condition
2. Energy is cleaner and regenerative
3 Disclosed embodiments would contribute to national security
17. Disclosed embodiments would contribute to improved environmental quality
18. Disclosed embodiments would stimulate economic development
19. Disclosed embodiments would not destroy environmental habitats
20. Disclosed embodiments would not cause harm to the inhabitants
21. Disclosed embodiments is less saturating
22. Disclosed embodiments is operable in confined spaces
23. Disclosed embodiment would prevent against geological congestions
24. Disclosed embodiments would prevent against historical view obstructions
25. Disclosed embodiments protects environmental and city needs
26. Disclosed embodiment is protected against turbulences
27. Disclosed embodiments are protected against extreme wind conditions
28. Disclosed embodiments is aimed at strengthening market capacity for sustained commercial operation of industrial/domestic energy enterprise
29. Disclosed embodiments comprise climate-friendly solutions for meeting industrial/domestic energy needs in a manner that is committed to sustainable market development.

Further embodiments provide wind generation apparatus operable for supplying wind/air flow to the interior part of the building structure 20. The generated wind/air flow is controlled for the operation of a wind and hydropower plant 10 and 12, with sufficient operating air/wind 150. Embodiments further provide apparatus being configured for adjusting to the required operating temperature for the wind energy plant 12 and/or the wind and hydropower plant 10 and 12. Some embodiments of the disclosure provide the pressure force generation apparatus being configured for increasing the inflow wind pressure and for directing the pressurized wind to energy generating mediums. Certain embodiments provide the energy generating mediums further comprising at least substrate-fiber configuration for generating electrical energy. At least one substrate microfiber further comprises a solar cell energy plant. Certain embodiments provide methods and systems of operations, including the operation of the wind and hydropower plant 10 and 12, which is moveable with the wind and hydropower energy plant door 80. The door may be opened or closed, and may be responsive to outside air. Other embodiments provide methods and systems for allowing the circulation of the outside air into the wind and hydropower energy plant 10 and 12. The wind and hydropower energy plant is configured with a fluid generation apparatus operable for propelling the turbine assembly 200, at least by pushing the inside air out. Still other embodiments provide the supplied air/wind 150 being circulated within the building structure for the wind and hydropower energy plant 12. Certain embodiments provide the fluid force generation apparatus further comprising the ventilation apparatus 100. Some embodiments provide the ventilation apparatus 100 being operatively configured for pushing and/or for pulling the air from the top of the building structure and downwardly and/or upwardly towards the exit channel. The air/wind 150 movements inside the enclosed wind energy plant 12 is enabled to propel the wheels/blades assembly 230 of the turbine assembly 200.

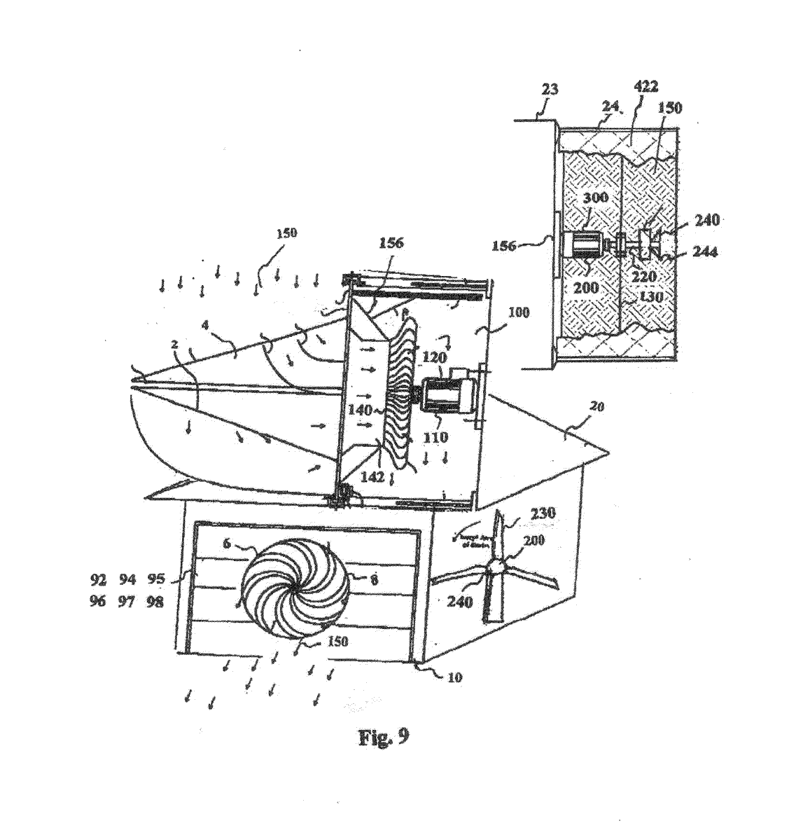

Referring to FIG. 9 is seen further exemplary embodiments of the tunnel, comprising a channel plow. Disclosed embodiments provide a tunnel 23 comprising a flow tube assembly 24 being disposed with the turbine assembly 200. The turbine assembly is being configured with rotor assembly 240. In some embodiments of the disclosure, the air/wind 150 from the flow tube assembly 24 may be routed in a radial direction to propel the turbine mechanical components, including the rotor assembly 240. Certain embodiments provide the turbine assembly 200, operatively connected to a generator assembly 300. Further disclosed embodiments provide an exemplary embodiment of the fluid force generation apparatus, including the ventilation apparatus 100, which may be positioned to optimally supply airflow 150 for the operation of the turbine assembly 200. In other embodiments, the ventilation apparatus 100 comprise a moment arm 142 communicatively connected to the air scoop assembly 140. Certain embodiments of the disclosure include stabilizing vanes assembly 156 in communication with the air scoop assembly 140 being configured to increase the inflow rate of air/wind 150 and to effectively and efficiently propel the turbine assembly 200 to generate clean renewable energy efficiently.

Certain embodiments of the disclosure provide a communication apparatus, comprising controls 92, 94, 95, 96, 97, and 98. In one embodiment, control 92 is configured with at least a manual switch 97. Switch 97 further comprises On/Off operatively configured to provide safe operative conditions of the ventilation apparatus 100. Certain embodiments of the disclosure further comprise one or more controls 92, 94, 95, 96, 97, and 98 each configured for sensing one or more different conditions within the enclosed wind energy plant 12, and/or the building structure 20. Some embodiments provide the controls 92, 94, 95, 96, 97, and 98 further comprising apparatus operatively configured for communications, further responsive to thermal conditions for controlling the wind plant 10 and/or hydropower plant 12.

Further embodiments provide methods and systems for controlling the enclosed wind and hydropower plant 10 and 12, including a thermostat comprising thermal control 95 being configured for sensing the temperature within the building structure 20, for effectively operating the wind energy plant 12. Some embodiments provide the thermal control 95 further comprising methods and systems for sensing the temperature of the exterior ambient air that might be pulled into the wind energy plant 12 and/or the hydropower plant 10. Some embodiments provide methods and systems for adjusting the temperature within the building structure to enable efficient and/or effective operation of the plants 10 and 12. Certain embodiments provide plurality fan motors 120 each being energized when any one or more sensed conditions reaches a predetermined level. The thermal control 95 may be subjected to the sensing of a controllable temperature and/or current for the operation of wind and hydropower energy plant 10 and 12.

Other embodiments of the disclosure include at least a safety control switch 97, which is manually controlled, and/or electronically controlled. The safety switch 97, being further configured for stopping the fan motors 120 independently and/or for preventing the fan motor 120 from starting. Some embodiments of the disclosure include means for preventing back pressure to the turbine wheels/blades assembly 230. Other embodiments provide methods and systems of generating renewable energy from an enclosed environment. The enclosed environment further comprising exit ports 250. Certain embodiments of the disclosure environment further comprising methods and systems for generating additional enhanced power responsive to the enclosed wind energy plant 10 and 12.

Disclosed embodiments further provide the turbine assembly 200 being configured with over-speed limiting apparatus for controlling the speed or velocity of the supplied air/wind 150. Embodiments further provide the rotor 240, comprising at least air foiled wheels/blades assembly 230 and/or a combination of air foil blade 230 and bucket type turbine blade 244 each operatively configured to enable the operation of the turbine assembly 200. The operation further includes utilizing both the highest and lowest wind speeds. Some embodiments include a bucket or impulse blades 244 being configured for maximum torque. The turbine assembly is configured for enclosed wind turbine applications, utilizing at least the minimum/maximum possible wind speeds. Certain embodiments as exemplified comprise the air foil design being further configured to provide optimum overall wind performance and torque for the operation of the wind and hydropower energy plant 10 and 12, even at higher supplied wind speeds.

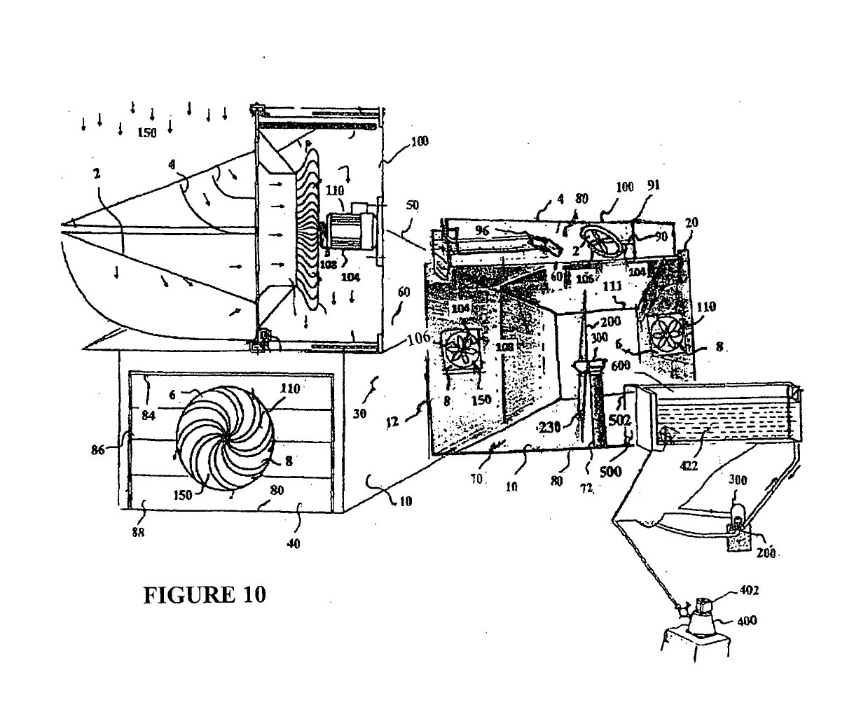

Referring to FIG. 10 is seen further exemplary embodiment of the building structure 20, being affixed with the fluid pressure force generation apparatus. The fluid pressure force generation apparatus further comprising the ventilation apparatus and/or the hydropower apparatus, each operable for providing propellant for the wind and hydropower plant operation. Embodiments provide fluid force generation apparatus, further comprising methods and systems for operating an enclosed wind and hydropower plant 10. The fluid force generation apparatus is configured for generating fluid pressure force to rotate a wind turbine assembly for the generation of renewable electrical energy. Disclosed embodiments further provide an enclosed environment, comprising a building structure 20 being affixed with at least a wind turbine assembly 200, and/or at least a water turbine assembly 200. At least one turbine assembly is being configured for converting fluid pressure into electrical energy. Certain embodiments of the disclosure provide methods and systems for generating controllable renewable electrical energy. Some embodiments provide the at least one form of generated energy being deployed for the operation of at least a turbine assembly to generate electrical energy. Other embodiments provide the fluid force generation apparatus further comprising at least a mechanical device comprising a motor assembly, a pump device assembly 400, and at least a compressed air device assembly 500.

At least one or a combination of both device assemblies 400, 500 being configured for generating fluid pressure force, further comprising creating compressed air and/or mechanical hydropower fluid pressure. Certain embodiments of the hydropower device assembly 400 comprise regenerative dam 600. Some embodiments provide methods and systems for operating a regenerative dam 600. The regenerative dam 600 could be pump operated. Still, certain embodiments of the disclosure comprise a ventilation apparatus comprising at least one or both devices 100, 400 operatively configured for providing fluid suctions. The fluid suctions may comprise fluid entrance channel. Disclosed embodiments further provide methods and systems to overcome environmental issues commonly found in conventional wind and hydropower plant. Conventional wind and hydropower plants utilize exposable wind turbines and other massive dams. Embodiments provide an enclosed system that may be operable at low cost wind, and/or at low cost hydropower to operate a plant for generating renewable electric power without consumption of fuel oil resources and/or creating pollution, or creating greenhouse gas emission. Certain embodiments provide the wind and hydropower plant 10 being configured to be operated independently as a wind turbine energy generation plant and/or as a combination of wind turbine and hydropower plant. Additionally, embodiments provide fluid force generation apparatus comprising at least one of: a ventilation apparatus 100, and a hydropower device assembly 400. At least one device could be positioned at the top of one or more stacks for generating fluid pressure for a power plant, and for increasing fluid flow rate.

Disclosed embodiments provide wind turbine plant operation that comprises a non conventional wind and hydropower plant 10 configured with devices for supplying air/wind 150 and/or for controlling sufficient interior environmental conditions, including temperature conditions of the building structure 20. Embodiments further provide renewable energy production method consisting of a regenerative wind and hydropower plant 10. Certain embodiments of the disclosure provide a renewable energy production method comprising an enclosed environment configured with apparatus for supplying the wind and hydropower plant 10 with fluid 422 to enable operations of the wind and hydropower turbine assemblies 200.

Disclosed embodiments further provide renewable electrical energy generation methods comprising a ventilation apparatus 100 operatively configured for supplying operational air/wind 150 to at least the turbine assembly 200 for enabling the operation of an enclosed wind energy plant 12. Other embodiments of the disclosure provide a renewable energy generation methods comprising the turbine assembly 200 being responsive to enclosed regenerative pressure. Disclosed embodiments provide methods and systems for producing reliable, effective and efficient renewable electrical energy. Embodiments provide advanced methods that are configured for a wind and hydropower plant operation, and include fluid pressure force generation mechanisms that are being enclosed in a building structure 20. Embodiments provide useful applications for generating renewable electrical energy to overcome environmental problems. Disclosed embodiments further provide methods and systems for generating renewable electrical energy, including the protections of environmental inhabitants. Disclosed embodiments provide innovative methods and systems that can be very useful for renewable energy plant operations even without the free-movement of natural wind and/or the creation of conventional dams.

In some embodiments of the disclosure, the ventilation apparatus 100 is horizontally mounted. In other embodiments of the disclosure, the ventilation apparatus 100 is vertically mounted. Certain embodiments of the disclosure provide fluid pressure force generation method that is angularly mounted. Embodiments provide wind generating apparatus comprising door and/or roof mounted ventilation apparatus 100 for supplying the operating pressure force for the wind energy plant 12. At least other embodiments provide the operating pressure force further comprising propellants for enabling the operation of turbine assembly 200. The turbine assembly 200 is being configured for generating renewable electrical energy. Certain embodiments further provide the fluid pressure force generation apparatus further comprising a roof/ceiling 60 mount ventilation apparatus 100 for supplying the wind energy plant 12 with propellant for operating turbine assembly 200. The turbine assembly is further configured for generating renewable electrical energy. The wind energy plant 12 further affixed with a ventilation apparatus 100. In certain embodiments, the ventilation apparatus is door 80 mounted. In some embodiments, the door 80 may be a solid door and or a tilt-able door 80. Some embodiments of the disclosure provide the fluid pressure force supply methods, comprising tilting the door 80 from the vertically closed/opened position for supplying operating air/wind 150 into the building structure for the operation of the wind energy plant 12.

Certain embodiments of the disclosure further provide horizontally mounted apparatus in closed/opened position for supplying operating air/wind 150 for the operation of the wind energy plant 12. Yet, disclosed embodiments further provide compressed air device assembly 500, comprising a pneumatic wind turbine operation for generating renewable electrical energy. The pneumatic wind turbine operation further comprises compressed air device assembly 500, air compressor assembly 502, air dryer 506, and air supply lines 508, being further configured for supplying the turbine assembly 200 with a supplemental proportionate operational air force to provide rotation for the operation of the turbine wheels/blades assembly 230, generating electrical energy. In this manner, the rotation of the turbine wheels/blade assembly 230 is being converted into mechanical energy. The mechanical energy is then converted into renewable electrical energy by a generator assembly 300.

The enclosed wind and hydropower plant 12 further comprising operating a wind turbine within the building structure 20. At least the wind turbine assemblies 200 is enclosed, responsive to wind generated by at least a ventilation apparatus 100. The ventilation apparatus 100 is provided to operate the wind energy plant 12. Certain embodiments provide the compressed air methods to operate the wind energy plant. The wind energy plant 12 is enclosed in the building structure 20, comprising walls 30, 40, 50, 60 and 70. The walls comprise the side walls 30, the front walls 40, the back walls 50, and the roof/ceiling walls 60. Disclosed embodiments provide the ventilation-apparatus 100, which may be disposed on at least one wall. Other embodiments of the disclosure provides energy generation comprise the turbine assembly 200 being secured by at least a fastener 72 on the floor 70 of the enclosed wind energy plant 12. The wind energy plant door 80 comprises of opening 142 in the front walls 40. Certain embodiments of the wind energy plant door 80 include panels 84, 86, and 88, such as an upper panel 84, at least a medium panel 86, and a lower panel 88.

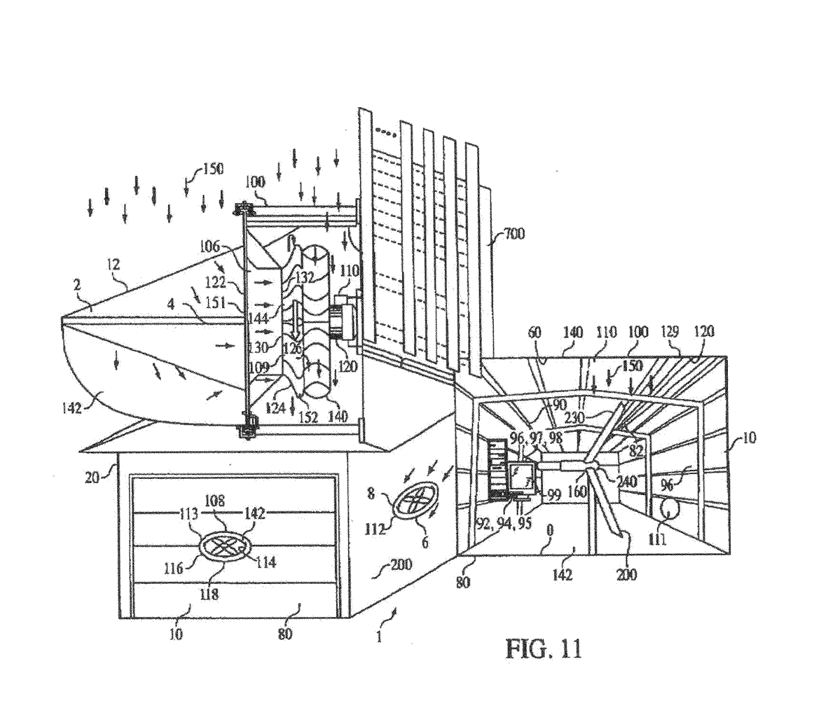

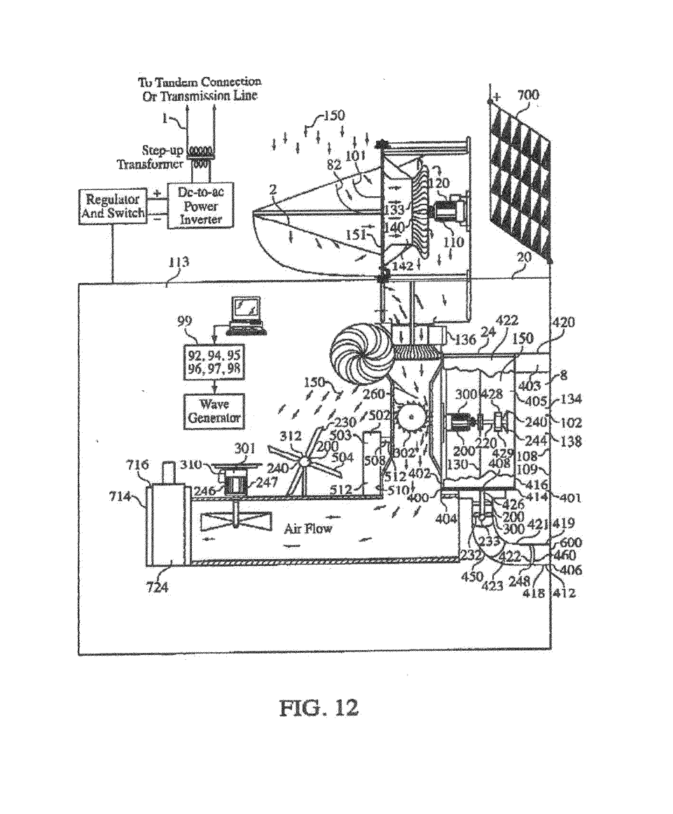

Referring to FIG. 11 is seen further exemplary embodiment of the building structure 20, further comprising fluid pressure force generation environment. Some embodiments further provide an element of the building structure being affixed with electrical cord 90 for connecting the power source 111 to at least a control panel 92. At least one control panel may comprise a computer apparatus 99 operable similar to a wall switch 94. An exemplary embodiment of a wall switch 94 further comprises apparatus for enabling operations to activate the wind energy plant door 80 in an opened or closed position. Other exemplary embodiment of a wall switch further comprises apparatus for providing operations to activate and/or control the ventilation apparatus 100. The ventilation apparatus 100 may be disposed at the roof 60 and/or at the door 80. Further embodiments of the disclosure provide the computer apparatus 99 further comprising control panel 92, 94, 95, 96, 97, and 98. The computer apparatus 99 is communicatively configured with the ventilation apparatus 100 for generating the required operating fluid pressure force for the wind turbine assembly. Certain embodiments provide the ventilation apparatus 100 operatively configured with at least a fan motor 120. Some embodiments provide the fan motor 120 communicatively connected to at least a fan assembly 110.

Embodiments further provide the fan motor 120 operatively configured with the motor 120, wherein the motor is operable for providing rotation to the fan assembly 110 in one direction to cause air/wind 150 to flow through an opening 142 and cause the turbine wheels/blades assembly 230 to respond to the operation the air/wind pressure differential. The wind flow 150 is enabled into the building 20 to further initiate rotational motion of the wheels/blades 230. Certain embodiments provide apparatus for generating fluid pressure force to cause turbine rotation. Some embodiments provide the turbine rotation being transferred into mechanical energy. Other embodiments provide the mechanical energy being transferred into electrical energy. Certain embodiments of the disclosure provide the mechanical energy being transferred into electrical energy by a generator assembly 300, which is communicatively connected to the turbine assembly 200. The generator assembly 300 is communicatively connected to the turbine assembly 200. The turbine assembly 200, being in fluid communication with the operation of the ventilation apparatus 100 to receive the initial propellant.

Embodiments provide the turbine wheels/blades assembly 230 further comprises rotor assembly 240, responsive to the air/wind 150 that is being generated by the ventilation apparatus 100. The ventilation apparatus 100 is further responsive to electrical energy for providing the operation to generate the inflow fluid pressure force through an opening mechanism 130. The opening mechanism 130 is further provided for supplying the inflow of air/wind 150 into the building structure for the operation of the turbine wheels/blades assembly 230. Disclosed embodiments provide the ventilation apparatus 100 further comprising an actuate-able mechanism, which may be activated to an opened/closed position to allow the inflow of air/wind 150 and to close the mechanism 130 when the air/wind 150 is not desirable. Certain embodiments of the disclosure provide the ventilation apparatus 100, further comprising apparatus for accelerating the inflow rate of air/wind 150 for peak operation the enclosed wind turbine assembly 200 to generate renewable electrical energy at peak periods. Some embodiments provide enclosed environment comprising the building structure 20.

Additionally, in open flat terrain, a utility-scale conventional wind plant would require about 60 acres per megawatt of installed capacity and only 5% or less of this area is actually occupied by turbines. The other 95% remains free for other compatible uses such as farming/and/or ranching. Water use can be a significant issue in energy production, particularly in areas where water is scarce, because conventional power plants use large amounts of water for the condensing portion of the thermodynamic cycle. In coal plants, for example, water is used to clean and process fuel.

Besides, small amounts of water are used to clean wind turbine rotor blades in arid climates where rainfall does not keep the blades of conventional exposable wind turbines clean.

Disclosed embodiments further provide methods and systems for eliminating dust and insect buildup. Disclosed embodiments further provide methods and systems for preventing deformation to the shape of the airfoil. Further embodiments of the disclosure provide methods and systems for improving performance. Disclosed embodiments further provide methods and systems that would extend turbine life. Embodiments further provide apparatus for effectively producing renewable electrical energy efficiently. Further embodiments provide apparatus for producing renewable electrical energy through enclosing wind turbine assemblies similar to conventional plant models, while preserving further usage of water per unit of electricity produced. Certain embodiments provide an efficient energy generation system when comparable to the amount of water being used by nuclear energy plants, coal energy plants, and natural gas energy plants to clean renewable electrical energy.

Certain embodiments further provide at least a diffuser 170. Disclosed embodiment further comprise the ventilation apparatus 100 operatively configured for supplying controlled flow rate of air/wind 150 for operating an enclosed wind energy plant 12. Some embodiments further provide the communication apparatus further comprising at least an automatic controller 92 operatively configured for providing the control energy to efficiently operate the ventilation apparatus 100. The ventilation apparatus 100 is being configured for supplying the operating air/wind 150 for the enclosed wind energy pant 12. Other embodiments provide the enclosed wind energy plant 12, and the ventilation apparatus 100, comprising at least a ridge and/or soffit ventilation apparatus 100. The ridge ventilation apparatus 100 and/or a soffit ventilation apparatus 100 being operatively configured for supplying operating air/wind 150 for the wind energy plant 12. Disclosed embodiments provide effective electrical energy generation system that is enclosed and configured to allow inflow of air/wind 150 through at least soffit vents 102 and out through the ridge vents 104. Embodiments provide protection to the roof/ceiling 60 of the wind energy plant 12 by cooling and drying the inflow of air/wind 150. Certain embodiments provide the protection further comprising a thermostatic control system.

Disclosed embodiments provide the computer apparatus further comprising wall control panels 92, 94, 95, 96, 97, and 98, being operatively configured with the ventilation apparatus 100 and communicatively connected to the air/wind access door 80 for the wind energy plant 12. Certain embodiments further provide the communication apparatus further comprising a transmitter 98 operatively configured for closing the ventilation apparatus 100 for the wind energy plant 12. The transmitter 98 is further configured for minimizing and/or maximizing the flow rate of air/flow 150 to efficiently operate the wind energy plant 12. Disclosed embodiments provide electrical energy generation plant, comprising methods and systems of operation that may further require at least a control panel and/or the transmitter 98. The operation of the control panels and the transmitter further provide a reversible means configured to reverse the flow direction of the fan assembly to minimize and/or maximize the ventilation apparatus output. Other embodiments of the disclosure further provide the ventilation apparatus 100 being mounted to the side 30 of the building structure 20 for the wind energy plant 12. Some embodiments further provide the ventilation apparatus 100 being ducted to the outside 0 of the wind energy plant 12. The ducted portion being supplied with vents without further creating massive holes in the building 20.

Embodiments further provide the ventilation apparatus 100 further comprising apparatus for directing outside air/wind 150 into an enclosed environment 20 to operate at least a turbine assembly 200 for the energy plant 12. Certain embodiments further provide means of operation comprising apparatus 112 for carrying the inside air/wind 150 for the wind energy plant 12 to the outside environment 01. The configurations for the energy plant 12 further include the air/wind 150 being controllable from the disposure of the ventilation apparatus fan assembly 110 through at least a duct 106 to operate the turbine assembly 200 affixed inside the wind energy plant 12. Other embodiments of the disclosure further provide the ventilation apparatus in association with ports 108 and or flap-able ports 109 being disposed on the wind energy plant door 80 and/or walls 40, 50. Disclosed embodiments further provide the ports operable for allowing air/wind 150 to be forced into and/or out of the wind energy plant 12. Certain embodiments of the disclosure further provide at least a fan assembly 114 being coupled to the ports 108, and 109.

Disclosed embodiments further comprise the fan assembly 114 being configured to exhaust the in flow of air/wind 150 out of the wind energy plant 12. Some embodiments of the fan assembly 114 further include an outer wall 116, configured for cavity and having air inlet 118 formed at its inside end 113. Further comprising the air/wind being further exhausted to the outside environment 01. Certain embodiments of the disclosure provide the air inlet 118 being responsive to the operation of the fluid pressure force air/wind 150. Some embodiments provide the ventilation apparatus 100 further disposed to at least an inner wall 122, being fastened to the outer wall 124, and positioned in the cavity environment 112 for allowing operation of at least a flow chamber 126. Disclosed embodiments further provide the flow chamber 126 being configured for accelerating the inflow of air/wind 150. In other embodiments, at least a motor 120 is operatively configured with the flow chamber 126, and communicatively connected for driving the fan assembly 110. Embodiments further provide a shaft means 129. The motor 120 is connected to the fan assembly 110 by at least a shaft means 129. Some embodiments provide at least a coupling 132. The coupling 132 is operatively connected to the flow chamber 126, and communicatively connecting the ventilation apparatus 100. The ventilation apparatus 100 is further configured with the shaft means 129 and the fan 110.

Referring to FIG. 12 is seen further exemplary embodiments of the wind and hydropower plant. Disclosed embodiments provide the fan assembly 110 further comprising a fan wheel/blade 133 being configured for controlling the inflow of air/wind 150 to the interior 113 of the building structure 20, for pulling atmospheric pressure into the wind and hydropower energy plant 12. Solar power 700 is further provided, comprising nano-sensors being embedded in silicon substrate, and fused/etched in a nano-fiber material to enable solar cell. Certain embodiments provide the solar cell further provided for supplying the initial operating energy for the ventilation apparatus 100 and the pumps. Some embodiment provides the solar cell being disposed to further enabled a solar power plant. Further embodiments of the disclosure provide the air/wind flow outlet 8, being configured to direct the inside wind pressure outwardly through at least an air/wind band 134 disposed within the wind energy plant 12. Disclosed embodiments provide the ventilation apparatus 100 further comprising the fan assembly 110. The fan assembly 110 being further disposed for generating fluid pressure force. Certain embodiment provides the fan assembly 110 further comprises a wind generating apparatus being configured to provide fluid pressure force to propel the turbine assembly 200.

Certain embodiments of the disclosure provide apparatus for generating air/wind 150. Some embodiments provide the air/wind 150 being drawn out of the building structure 20 through the exit pot 8 by the fan assembly 110. Other embodiments provide the fan assembly 110 further comprising methods and systems for operating a turbine plant inside a building structure 20. The building structure further comprises operational configuration for the wind energy plant 12 to be controlled via mechanical and/or electronic control elements 92, 94, 95, 96, 97, and 98. Disclosed embodiments provide the mechanical and/or electronic control elements 92, 94, 95, 96, 97, and 98 further comprises a communication apparatus comprising a computerized control means 99. Other embodiments of the disclosure further provide hoods 136, being operable for supplying the turbine assembly 200 with the operational amount of air/wind 150. Some embodiments provide ports 108, and 109, further comprising at least a manifold 138 being operable for venting inside air/wind 150 outwardly.

Embodiments further provide methods and system for generating renewable electrical energy, further comprises fluid pressure force apparatus comprising plurality of ventilation apparatus 100 being configured for providing communications to plurality wind turbine assembly 200. At least one ventilation apparatus 100 is disposed in a building structure 20. The fluid pressure force generation apparatus is further configured to extend centrally, distributive, vertically/horizontally/and/or angularly therefrom. Certain embodiments of the disclosure provide air intake assembly 101 comprising intake ports/openings 82 communicatively connected to a central airflow supply 140. The air intake supply 140, being in communication with airflow exit 102, comprising of smaller diameter exit port. Some embodiments of the disclosure provide the air intake assembly 101, being operatively configured to supply air/wind 150 to drive at least a turbine assembly 200. Disclosed embodiments provide the turbine assembly 200 being communicatively connected to a generator assembly 300. The generator assembly 300 comprises apparatus for converting mechanical energy into renewable electrical energy. Disclosed embodiments further provide the generator assembly 300 being communicatively connected to a power storage medium. Certain embodiments provide a power storage medium comprising of transformers and/or grids 001. The power storage medium 001, being operatively configured to further supply the operating power to at least one of: a compressed air apparatus 500, a mechanical pump assembly 400, a hydraulic pump assembly 402, and/or fluid pump assembly 404.

Certain embodiments provide exemplary embodiment of generator assembly 300, being configured to provide electrical power in a range exceeding 1 kW and 250 MW of rated power. Embodiments provide the generator assembly 300 responsive to the turbine assembly 200. The generator assembly further comprises advanced technology. Certain embodiments provide the generator assembly further comprising permanent magnet generator assembly 310. The permanent magnet generator assembly 310 further comprises at least a gearless design 312 configured to maximize small- to mid-size operation of an exemplary embodiment of the wind energy plant 12. Some embodiments provide the wind energy plant 12 further comprises electrical energy generation plant consisting of methods and systems that are highly reliable and could produce renewable electrical energy at low maintenance cost. The wind energy plant 12, in certain embodiments, is further configured with the generator assembly 300 for maximum wind energy capture and for generating renewable electrical energy. Other disclosed embodiments provide further provide the wind energy plant 12 comprising methods and systems for generating directional array of air/wind 150, in communication with the turbine assemblies 200. Each wind turbine assembly 200 comprises a housing 246 operatively configured with blades/wheels 230.

Embodiments further provide the blades/wheels 230, further responsive to the inflow of air/wind 150 therethrough. The turbine assembly 200 further comprises ring gear 260 in communication with the generator 302. The generator assembly 302 further comprising multi-directional generators, each operatively configured for converting mechanical energy into electrical energy. Certain embodiments provide an exemplary embodiment of the ventilation apparatus 100. The ventilation apparatus further comprising fluid pressure force generation apparatus, each comprises means for accelerating the inflow of wind 150 for allowing efficient operation of the turbine assembly 200. Disclosed embodiments further provide the fluid pressure force generation apparatus further comprising methods and systems for maximizing the torque being transferred by the turbine assembly 200. Certain embodiments provide the torque further comprising the rotational energy of the turbine assembly. Some embodiments provide the rotational energy being converted into renewable electrical energy by the generators 302.

Disclosed embodiments further provide exemplary embodiment of fluid pressure force generation apparatus comprising compressed air assembly 500. Certain embodiments provide the compressed air assembly 50 further comprises at least an air compressor assembly 502. The air compressor assembly 502 in further communication with at least a control means 503. The control means 503 may comprise a control valve 504, at least an air dryer 506, and at least supply lines 508. Certain embodiments provide the compressed air assembly 500 further comprising pressure valves 510, operatively connected to a supply port 512. The supply port 512, further comprising means for supplying at least the generated airflow 150 into the building structure 20 for the operation of at least a turbine assembly 200. Some embodiments of the disclosure provide compressed air apparatus for generating renewable electrical energy.

The controlled airflow 150 is being generated to be channeled within the building structure 20 to propel turbine assemblies 200 for the enclosed wind and hydropower plant 10. In some embodiments, the airflow 150 is being generated by at least an air compressor 502. Other embodiments provide the air compressor 502 further comprising methods and systems for generating the airflow 150. Further comprising at least a ventilation apparatus 100 operatively configured for supplying ground ambient air/wind 150 into the wind energy plant 12. Disclosed embodiments provide the airflow 150 being directed for propelling the wind turbine assembly 200. Embodiments provide the fluid pressure force generation apparatus in fluid communication with air intake ports 151. Certain embodiments provide the flow of air/wing 150 for turning a turbine wheels/blades assembly 230. Some embodiments provide the turbine wheel/blades in association with a drive shaft assembly 220. The drive shaft assembly 220 is further communicatively connected to generator assembly 300. Certain embodiments of the disclosure include the pressure control valves 510 operatively connected to the air compressor 502. Other embodiments provide the control valve 510 being configured with at least a computer apparatus. The computer apparatus further comprising at least an automatic controller 514.

The automatic controller 514 is further operatively configured for regulating the airflow rate to the turbine assembly 200. Further embodiments of the disclosure include an enclosed wind energy plant 12, comprising means for generating fluid pressure force for the generation of renewable electrical energy. The electrical energy generation is enabled through the rotation of a turbine wheels/blades assembly 230. Disclosed embodiments provide compressed air methods and systems for creating mechanical energy to generate renewable electrical energy. Other embodiments provide the mechanical energy being created from the rotation of the wheels/blades assembly 230. Disclosed embodiments further provide the turbine assembly 200 comprising methods and systems for converting mechanical energy into electrical energy. Other embodiments provide the mechanical energy being converted into renewable electrical energy by at least the generator assembly 300.

Embodiments further provide the rotation of the wheels/blades assembly 230 being enabled by the controlled flow of air/wind 150 to the wind turbine assembly 200. Certain embodiments further provide the air/wind 150, flowing from a plurality of ventilation apparatus 100 to operate the turbine assembly 200. The turbine assembly is affixed inside the building structure 20, comprising an enclosed wind energy plant 12. Certain embodiments provide the wind and hydropower plant 10 further comprising a regenerative dam 600. Some embodiments provide the dam 600 being responsive to pump operated pressure 403. Other embodiments provide the dam 600 responsive to generated drag force 405. Still, other embodiments provide the dam 600 comprising regenerative falling water 406. Yet, some embodiments provide the enclosed wind and hydropower plant 10 further comprising hydropower energy generation apparatus 408. Certain embodiments of the hydropower energy generation apparatus 408 further comprise a land plant 401 consisting of channeled pumps in a building structure 20. Still, other embodiments of the hydropower energy generation apparatus 408 further comprises land based wind and hydropower plant 10, operatively configured with hydro-turbine assembly 200.

Some embodiments of the hydropower energy generation apparatus 408 further comprise apparatus for converting low pressure fluid into high pressure fluid. Certain embodiments provide the apparatus for converting low pressure fluid into high pressure fluid comprising a pump apparatus 412. Some embodiments provide the pump apparatus 412 further comprising a hydro pump assembly 414. Other embodiments provide the hydro pump assembly 414 further comprising a hydraulic pump assembly 402. Yet, other embodiments provide the pump apparatus 408 further comprising water pump assembly 416. Still, other embodiments of the pump apparatus 408 further comprise at least a mechanical pump assembly 400. Certain embodiments provide the pump apparatus 408 further configured with ports comprising an inlet 418 consisting of at least a suction side, and an outlet 420 consisting of at least a pressure delivery side. Some embodiments provide the ports 418 and 420 in association with at least a supply line 419 at the suction side of the pump in communication with at least a fluid 422, such as, as an example, water 423 and/or air 150.

Disclosed embodiments further provide the ports 418 and 420, in association with at least a delivery line 421 at the delivery side of the pumps apparatus 408, in communication with at least a turbine assembly 200. The turbine assembly 200 includes a housing 246, operatively configured to receive fluid 422 through an opening 248, comprising wheels/blades assembly 230. Yet, disclosed embodiments further provide the housing 246, further configured with apparatus for converting at least one form of energy into at least another form of energy. Certain embodiments provide the apparatus further comprising electrical generator assembly 300. The electrical generator assembly 300 is disposed in the housing structure 246. The electrical generator assembly 300 is responsive to the mechanical rotation 220 of the turbine assembly 200. The electrical generator assembly 300 is responsive to the operation of the turbine assembly 200, for generating renewable electrical energy. Some embodiments provide the turbine assembly 200, communicatively connected to wheels/blades assembly 230. The wheels/blades assembly 230 is disposed with opening 248, which is configured for receiving fluid flow 422. The wheels/blades assembly 230 is further operatively connected to an axle structure. The axle structure further comprising drive shaft assembly 220, being configured for converting fluidic kinetic energy into mechanical energy.

Certain embodiments provide the housing 246, further comprise an electrical generator 302; at least a turbine assembly 200 is disposed in the housing 246 in fluid communication with the opening 248, through at least an inlet channel 418. At least the fluid inlet channel 418 further comprises an entrance, and at least fluid exit channel 420 further comprising an outlet. The channels 418, 420 comprise means through which at least kinetic energy is converted into at least a form of energy. Disclosed embodiments provide methods and systems for operating a hydropower plant on still waters. Other embodiments provide the still water further comprise low pressure fluid being mechanically transported via the inlet and the outlet fluid line 418, 420, comprising the fluid line entrance and fluid line exit. Some embodiments provide the fluid line 418, 420 further comprise at least a pipe 450. Certain embodiments provide the pipes 450 comprising apparatus for controlling flow rate of fluid 422. Some embodiments provide the apparatus further comprising at least a flow valve 460. Still, certain embodiments provide the pipe 450 responsive to outlet pressure. Certain embodiments provide the pipes further comprise pressure differential channels, wherein the outlet pressure being greater than the inlet pressure. Some embodiments provide the outlet pressure communicatively connected to the wheels/blades assembly 230.

Disclosed embodiments provide the wheels/blades assembly 230 being communicatively connected to the turbine generator assembly 300. The turbine assembly 200 being responsive to the energy due to the fluid force. Disclosed embodiments further provide the generator assembly 300 being responsive to the mechanical energy created by the turbine assembly 200. The generator assembly 300 further comprises apparatus for converting the mechanical energy into renewable electrical energy. The housing 246 further comprises a turbine housing portion 247, and the generator housing portion 301. Embodiments provide the turbine assembly 200 being located in the turbine housing portion 247, and the generator assembly being located in the generator housing portion 301. Disclosed embodiments further provide the inlet channel 418 being configured to supply at least fluid to a pump apparatus 412. The pump apparatus 412 is being configured to increase the velocity of fluid flow. The turbine assembly is further configured with wheels/blades 230, being further responsive to the increased velocity of fluid flow. The fluid flow rate is controllable through peak period. Disclosed embodiments provide methods and systems to generate the amount of energy that is proportionate to the controlled pressure being exerted upon the wheel/blade assembly 230 to increase rotational speed.

Disclosed embodiments provide the enclosed energy plant further comprising reliable and effective methods and systems for generating renewable energy. Certain embodiments provide a dam 600 comprising water source. Other embodiments provide suction lines 418 and return/supply lines 420 communicatively connected to a high pressure water pump assembly 400. Some embodiments of the disclosure provide the return line 420 being operatively associated with a turbine assembly 200. The line 420 having openings 421 through which at least a paddle wheel 232 and/or a propeller runner 233 are being connected for communication with fluid. Certain embodiments provide the openings 421, further comprises at least a door 422, each being properly sealed to provide easy maintenance access to the turbine assembly 200. The paddle wheels 232 and/or propeller runner 233 further operatively configured to be disposed on at least an axle shaft 426. The axle shaft 426 further extending outwardly from the door 422, and the paddle wheel 232 and/or propeller runner 233 being inwardly connected to the door 422.

Certain embodiments provide the shaft 426 being configured with a mounting plate/yoke 428. The mounting plate/yoke 428 is firmly fixed and communicatively connected to the turbine assembly 200. Some embodiments provide the turbine assembly 200 being operatively configured with at least the shaft 426, being disposed with the plate/yoke 428. The plate/yoke 428 is proportionately bored 429 for connections to the shaft 426, in association with the paddle wheel 232 and/or propeller runner 233. Disclosed embodiments further provide the building structure comprising methods and systems positioning turbines via advanced configurations to prescribe an enclosed wind and hydropower plant 10. The prescription further comprises providing turbine assembly, affixing the turbine assembly in a building structure, supplying propellant through the building structure to enable advanced wind and hydropower plant 10 and 12. The advanced wind and hydropower plant provide effective method of operations and also cost effective methods of maintaining the turbine assembly 200. Other embodiments of the disclosure provide the turbine assembly 20 further comprise at least a reversible pump assembly 400. Some embodiments further provide the turbine assembly 200 being operatively configured for converting the potential energy stored in the pressured water 423 into mechanical energy for generating electrical energy. In one exemplary embodiment, pressure may be directed to substrate-microfiber 724, being configured with nano-tubes 714, communicatively connected to electrodes 716.

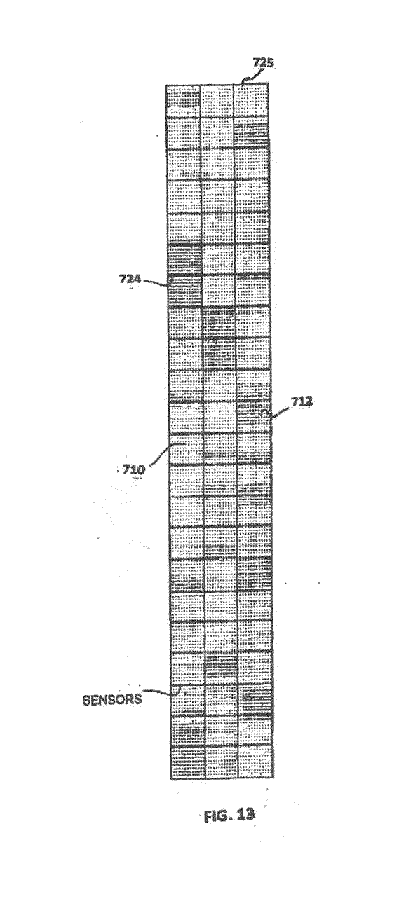

Referring to FIG. 13 is seen exemplary embodiments of nanotechnology application comprising substrate-microfiber 724. Certain embodiments provide the substrate-microfiber further comprises nano-sensors embedded in silicon substrate and etched/fused in nano-fiber material. At least one nano-fiber material further comprises material with excellent electrical characteristics. Disclosed embodiments provide the substrate-microfiber 724 further comprises solar cell comprising methods and systems for generating electrical energy. Some embodiments provide the substrate-microfiber comprising microfiber material 710 being configured with sensors on silicon substrate 712. Certain embodiments provide the substrate-microfiber 724 further comprising miniaturized non ferrous materials 734 being embedded in the silicon substrate 712. Some embodiments provide the substrate-microfiber 724 further comprising energy transport platform 725. Certain embodiments provide the silicon substrate 712 comprising at least glass-substrate 739

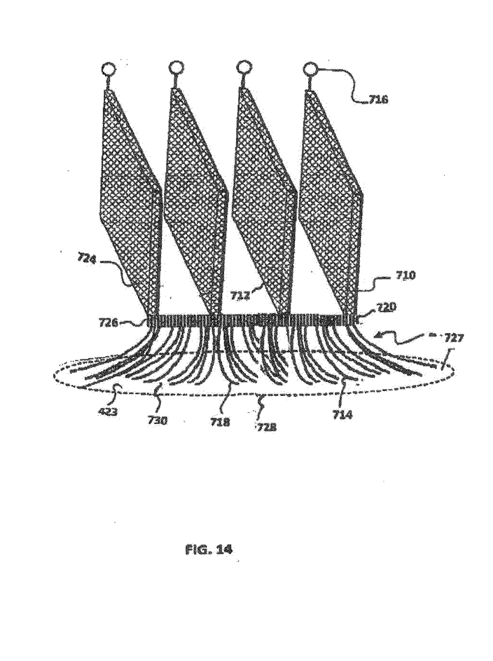

Referring to FIG. 14 is seen an exemplary embodiment of energy medium. Disclosed embodiments provide nano-materials comprising methods and systems for generating and storing electrical energy. Certain embodiments provide the nano-materials 710, further comprising at least one of: nano-fiber material; microfiber material; nano-fiber material being alloyed with miniaturized non-ferrous material. Embodiments further provide the microfiber material 710 comprising material with excellent electrical properties disposed with substrate 712. The microfiber material 710 further includes material components with nanometer dimensions in which at least one dimension is less than 100 nanometers. Some embodiments provide the microfiber materials further configured with nano-tubes 714, each nano-tubes being embedded in the silicon substrate 712. Certain embodiments provide the substrate 712, being configured with electrodes 716 in communication with the nano-tubes 714. Other embodiments provide the nano-tubes 714 comprising at least one component of: carbon char, carbon black, metal sulfides, metal oxides and other organic materials. At least one nano-tube being alloyed with the microfiber material 712. Disclosed embodiments further provide the alloyed microfiber material 712 comprising apparatus 718 configured for exhibiting unique electrical and electrochemical properties to enable efficient transportation of energy properties. Disclosed embodiments provide methods and systems for generating energy properties via high surface areas and charge transport medium.

Certain embodiments provide the charge transport medium being further derived from the flow of energy, such as, for example, pressured fluid 423. Disclosed embodiments further provide the energy further comprises apparatus for thermal expansion. At least one apparatus for thermal expansion is in communication with the nano-tubes 714. Certain embodiments provide the apparatus for thermal expansion further include passages of the fluid which may include water and/or material pyrolysis. Some embodiments provide the material pyrolysis further comprises energy medium. The energy medium comprises apparatus 720, comprising means through which electron transfer occurs at the electrode 716. Some embodiments provide the means through electron transfer occur further comprising the release of chemical energy to create a voltage through oxidation/reduction reactions 722. Other embodiments provide the oxidation and reduction reactions 722 being separated through the electron 716. Embodiments provide the electrode 716, being further configured with substrate-microfiber 724 comprising re-enforcement to external electric circuits. Certain embodiments provide the re-enforcement comprising at least a storage medium. Some embodiments provide the re-enforcement comprising storing internal voltages at electrodes, comprising providing useful energy for batteries 724 and capacitors 726.

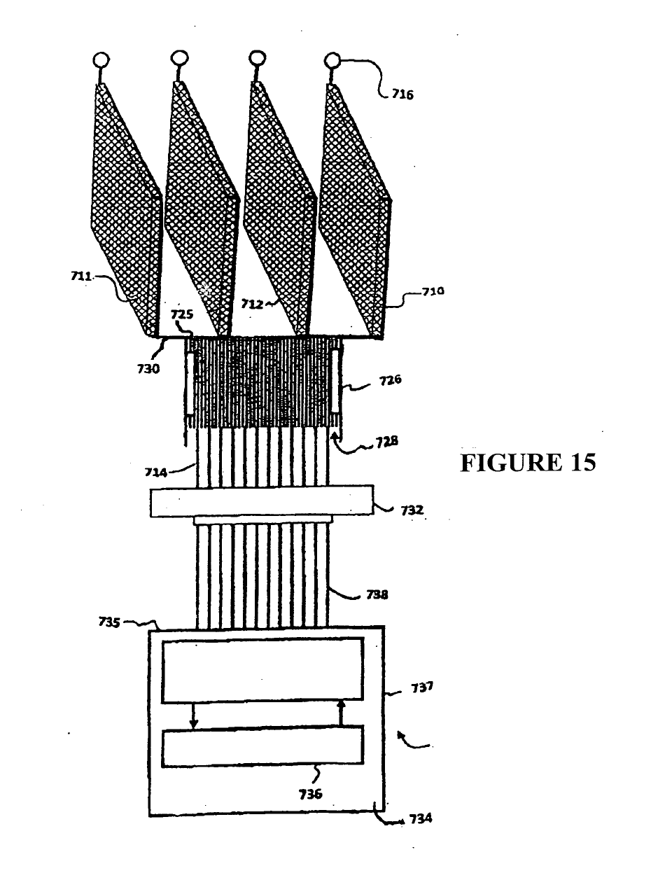

Referring to FIG. 15 is seen further exemplary embodiments of the energy medium. The energy medium further comprises energy storage apparatus 720. Disclosed embodiments provide methods and systems for generating electrical energy. Certain embodiments provide the energy medium further comprises electric current 728 being generated from the energy released by at least a reaction. Certain embodiments the energy medium further comprises microfiber material 710 being configured for converting pressure force and generating energy. Some embodiments provide the energy medium further comprises the energy being generated, comprising electrical energy 730. Other embodiments provide the energy being generated comprising thermal energy 732. The microfiber material 710 further comprises plurality textile fibers 711, being alloyed with zinc oxide (ZnO) nano-wires 734. Disclosed embodiments provide the zinc oxide nano-wire 734 being further configured with piezoelectric crystals for generating electrical current 728. Certain embodiments provide the energy further comprising current flow 730 from plurality fiber pairs 736. Other embodiments provide the fiber pairs being configured for converting at least one of: vibration, pressure, blood flow, sound, solar, waves, force, and other electrical properties into electrical energy 730. Some embodiments provide apparatus for generating pressure force and converting the pressure force into electrical energy. Disclosed embodiments provide methods and systems for converting the generated wind and water pressure into electrical energy. The wind and water pressure is communicatively connected to microfiber material 710. The microfiber material is being configured for converting pressure force into electrical energy 730. Some embodiments provide the microfiber material 710, further comprises nanotechnology applications.

Other embodiments provide methods and systems of generating renewable electrical energy through nanotechnology applications. The nanotechnology applications further comprise at least plurality layer microfiber 736. Other embodiments provide microfiber 710, further comprises miniaturized material arrays comprising nano-wire 734. The miniaturized material arrays further comprises nano-materials being configured for hybrid electrical generator assembly 738. Certain embodiments provide the generator assembly 738 further comprising of at least semiconductor properties consisting of non ferrous material arrays. The non ferrous material array further comprises vertically-aligned zinc oxide (ZnO) nano-wires 734. The zinc oxide nano-wire 734 is being configured to exhibit flexible electrode 716. Some embodiments provide the flexible electrode further comprising conductive platinum tips 735. Other embodiments provide the microfiber material 710 further comprising plurality fibers with excellent electrical properties. Embodiments provide the plurality fibers being coated with polymer and/or with zinc oxide layer 734 to provide energy transport platform 725. Certain embodiments provide the nano-wires 734 being further coated with gold 737, and fused or etched on the transport platform 725. Some embodiments provide the nano-wire being further configured for harnessing energy from a medium, such as, for example, sun. Embodiments provide the medium, further comprising at least one of: vibration, pressure, blood flow, sound, waves, and. Force. Other embodiments provide apparatus comprising zinc oxide (ZnO) 734 being embedded in a silicon substrate. Other embodiments provide the silicon substrate being configured with at least polymer.

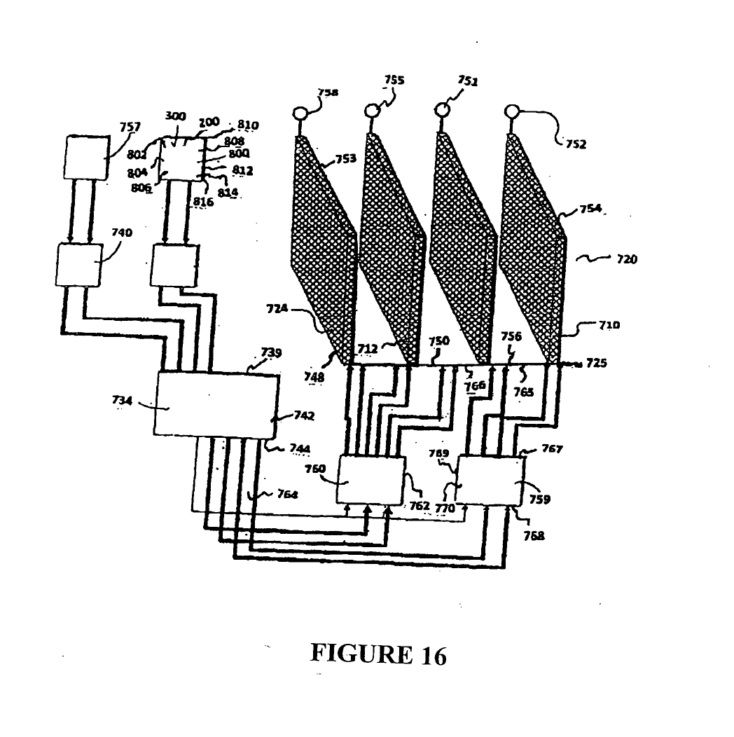

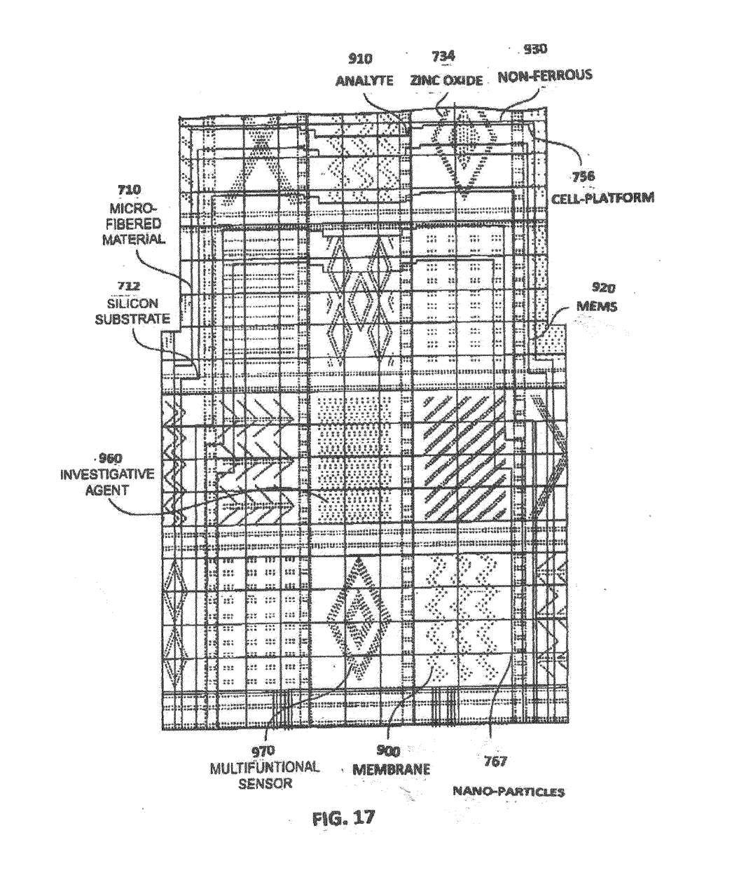

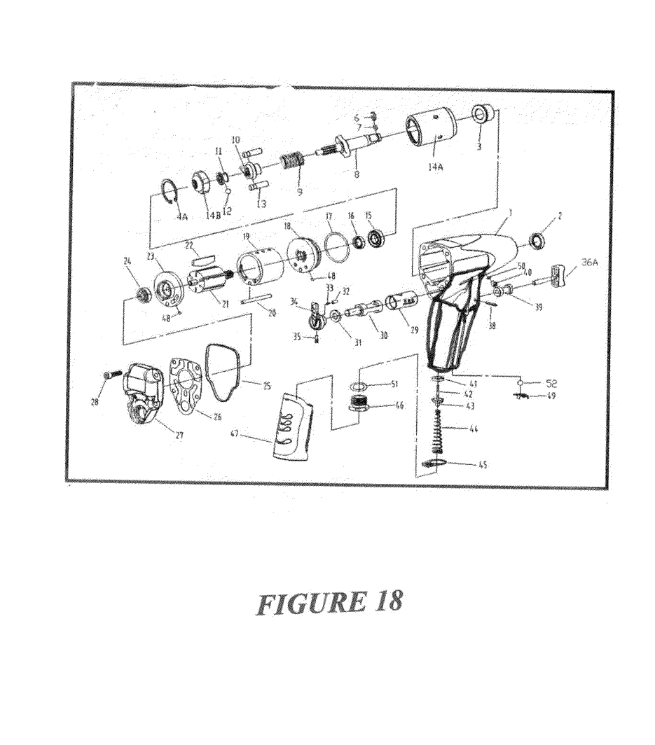

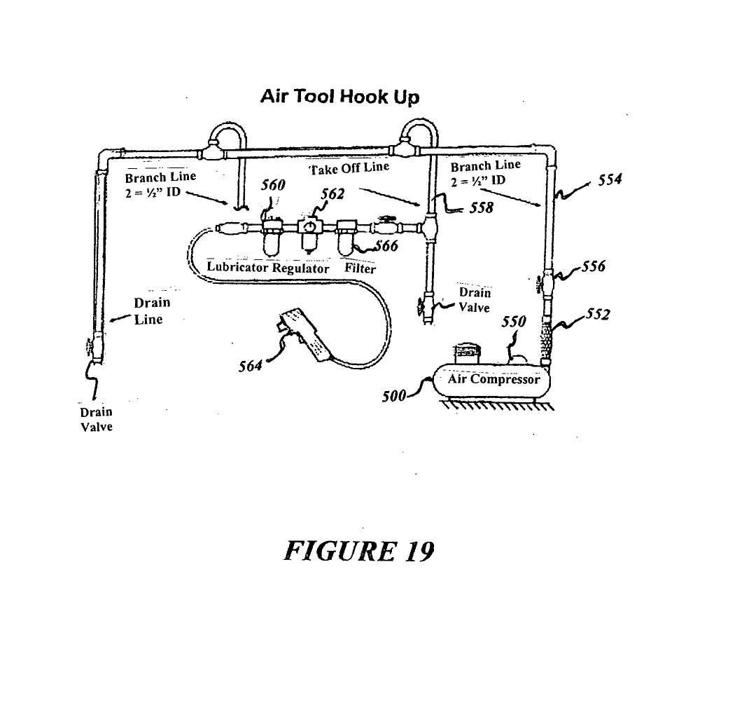

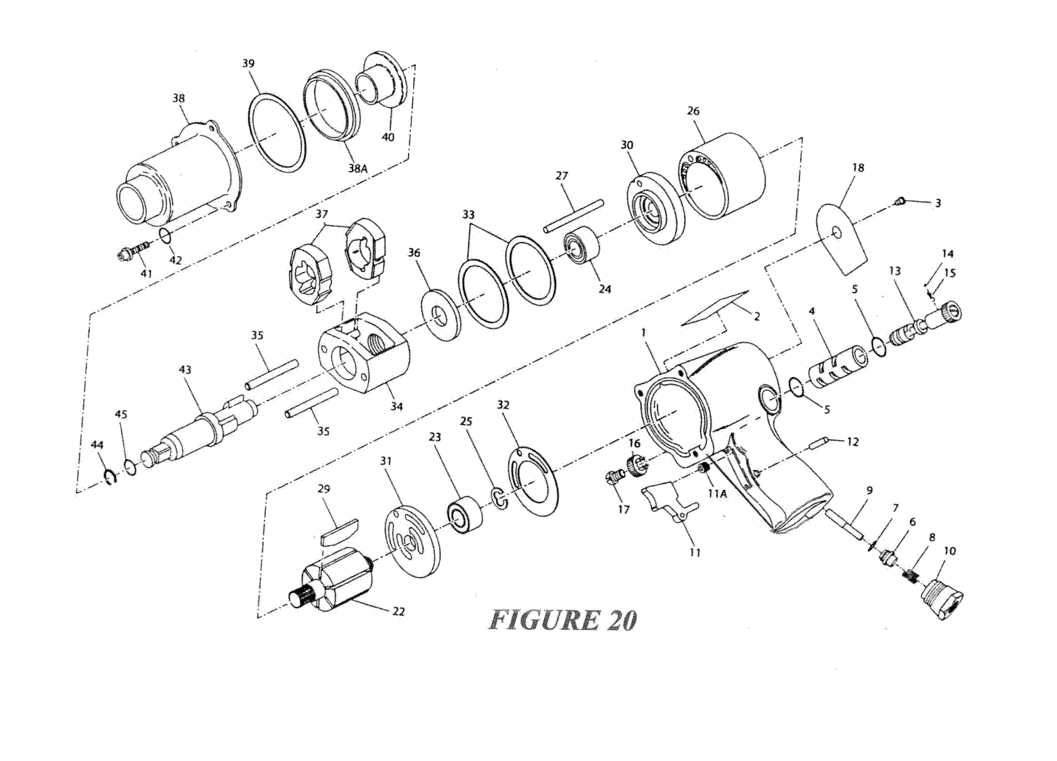

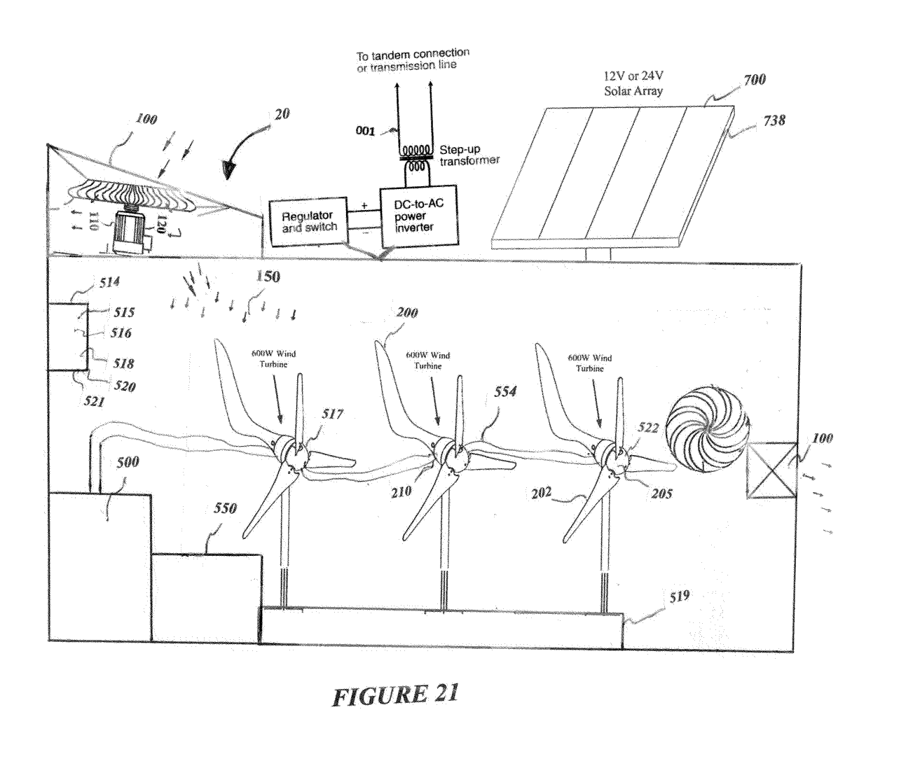

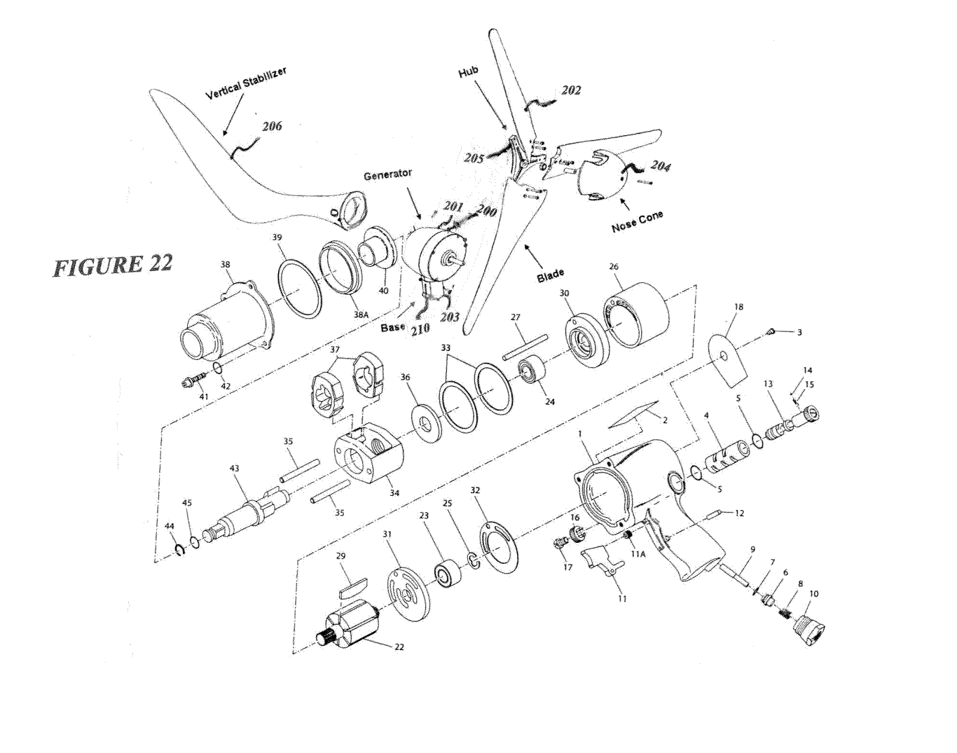

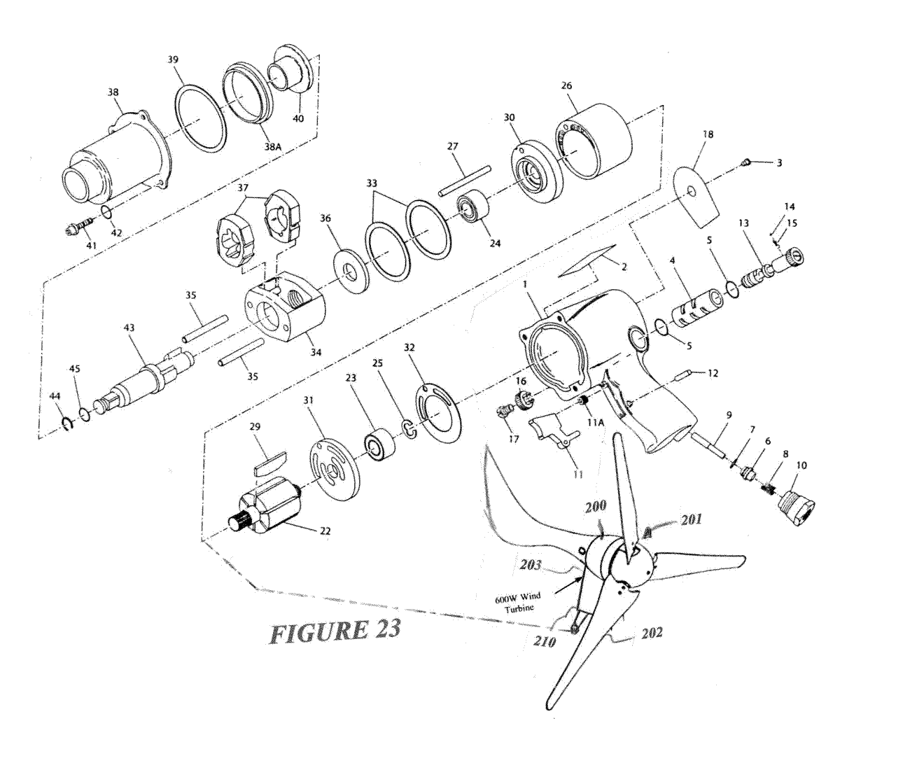

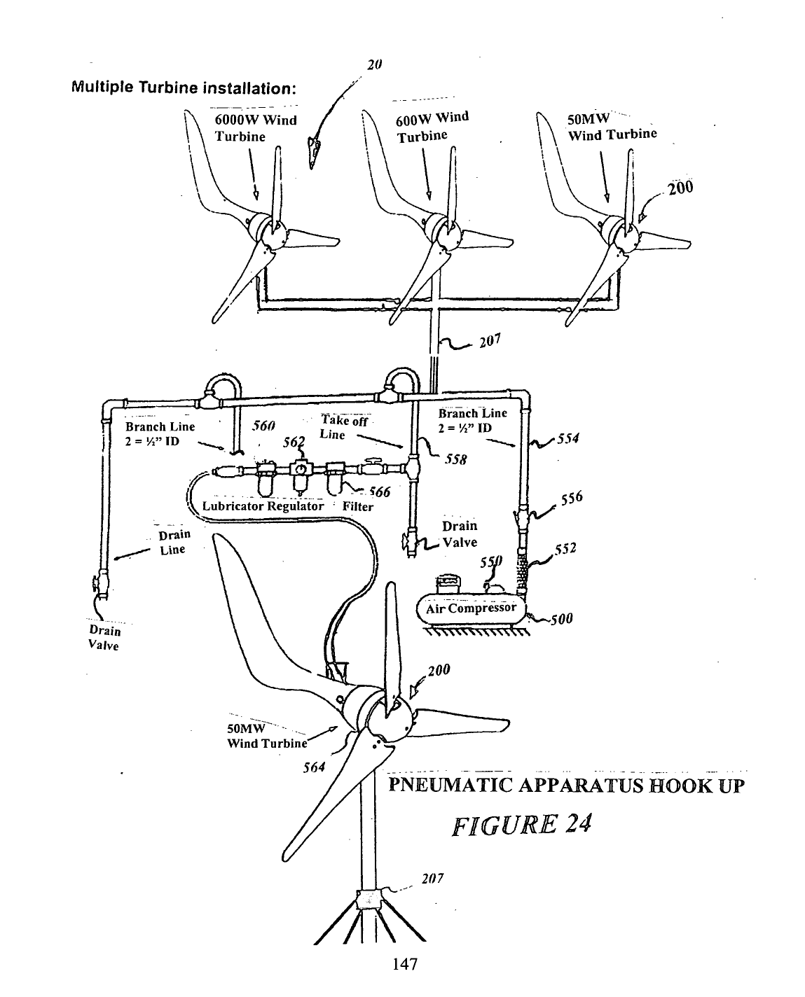

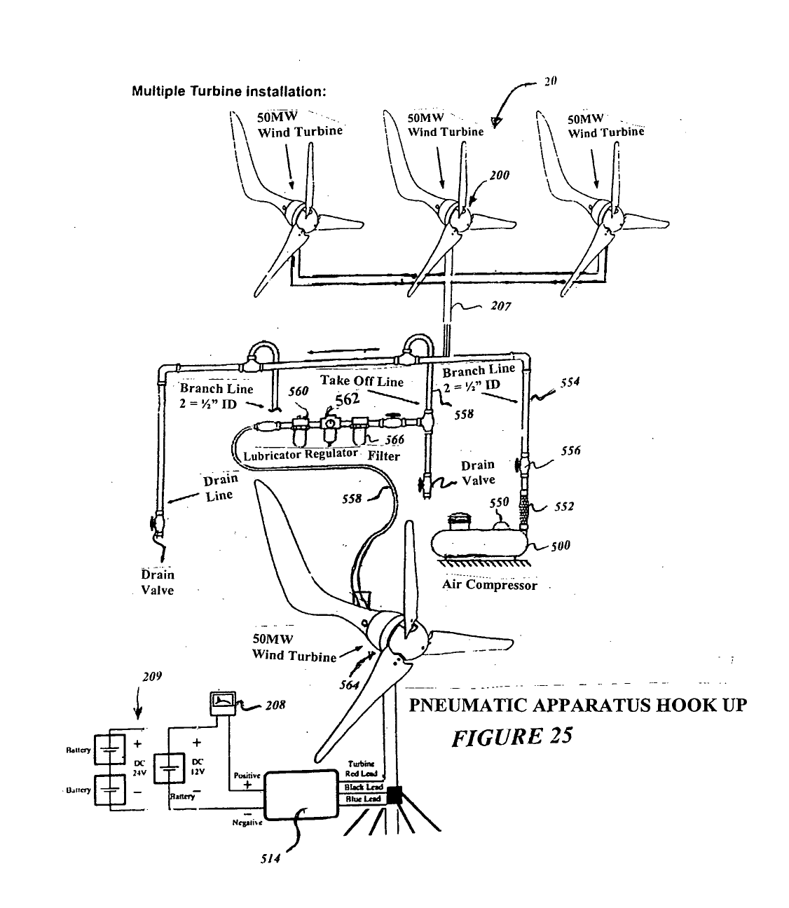

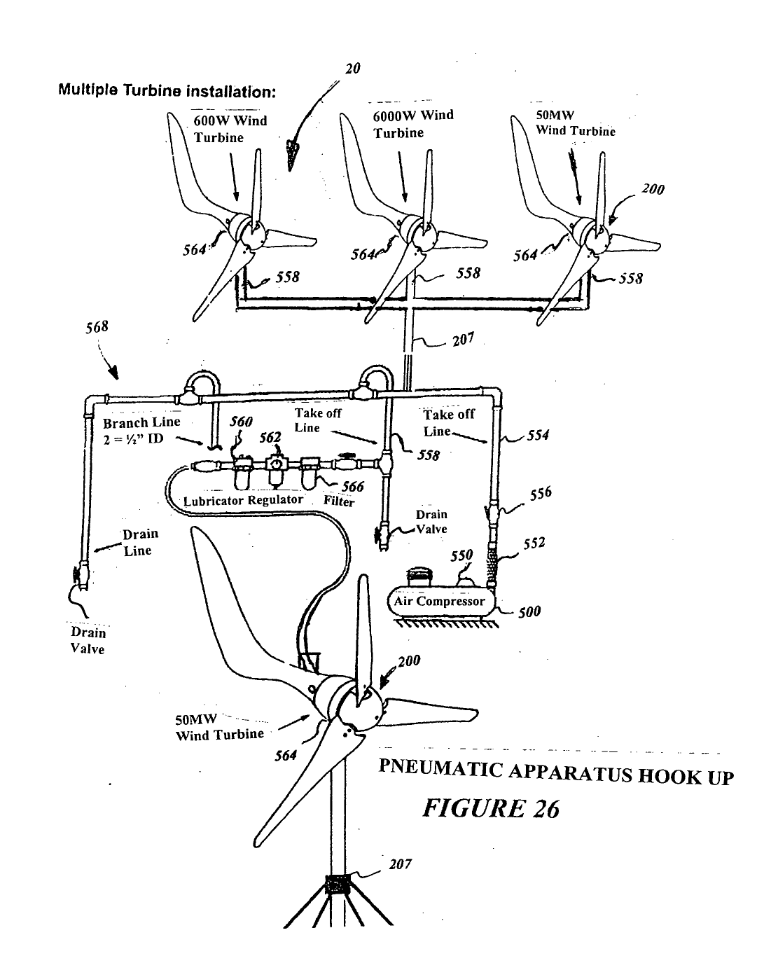

Referring to FIG. 16 is seen further exemplary embodiments of the energy medium. The energy medium further comprises electrical energy. Embodiments herein provide silicon-substrate-microfiber comprising energy transmission/storage apparatus 720. Certain embodiments provide force/data being converted into electrical energy. The force/data may be derived from at least one of: vibration, pressure, blood flow, sound, waves, solar force, and electrical properties. Disclosed embodiments further provide the silicon-substrate-microfiber comprising charge couple apparatus 740, being configured with miniaturized conduit particles 734. Certain embodiments of the conduit particles 734 comprise of at least glass 739. Other embodiments of the conduit particle comprise of at least Zinc Oxide (ZnO) and/or gold. Some embodiments provide the conduit particles further comprising at least non-ferrous material being alloyed with at least a substrate-microfiber 724.

Disclosed embodiments further provide the conduit particles further comprises conduit properties comprising at least glass fiber 739 being responsive to light data transmission. Further embodiments of the charge particle apparatus 740 comprises solar cell comprising electron-silicon substrate-oxide 742 configured with material with good optical properties for exhibiting effective sensitivity to electron range. Disclosed embodiments provide the electron-silicon substrate-oxide 742 further comprising coating to prevent glass-glass interface 744. Certain embodiments provide the silicon substrate 712, further comprising at least a material constituent of glass 739. Other embodiments provide the silicon substrate 712 being layered with fibers 710 to exhibit durability and better charged properties. Yet disclosed embodiments further provide a solar cell comprising the silicon substrate 712 being layered with nano-fibers 710. The silicon substrate being further layered with at least a conduit particle comprising of at least Zinc Oxide (ZnO) and/or gold.

The electrodes 716 further comprise of battery cells 748. Other embodiments provide the battery cells 748 further include electrolyte 750 comprising of cathodes 751 and anodes 752. The cathodes 751 comprising the oxidized form of the electrode metal and the oxidizations and reductions are controlled by the electrochemical potential being responsive to the thermal expansion, pressure, composition and concentration of the electrolyte 750. The electrical potential differenced being produced is the sum of the electrochemical potential at the electrode 716. Embodiments further provide the battery cell comprising Zinc batteries and/or zinc fuel cells 754 being configured for electrochemical power applications through the oxidation of zinc with oxygen from the air for exhibiting high energy density. Certain embodiments provide the battery cell comprising nano-materials 734 being embedded in the substrate 712 and etched/fused in the microfiber material 710 to provide advanced cell platform 756. Some embodiments provide the cell platform 756 being communicatively connected to the electrodes 716. Other embodiments provide the cell platform 756 further comprises battery cell 753. Yet, other embodiments provide the cell platform 756 further comprises fuel cell 754. Disclosed embodiments provide the cell platform 756 being further configured for medical devices applications 757. Other embodiments provide the cell platform 756 further comprises electric vehicles applications 758.

Disclosed embodiments further provide the cell platform 756 comprising nickel-cadmium batteries (NiCd) 758 configured with nickel oxide hydroxide and metallic cadmium 760. Embodiments provide the nickel oxide and metallic cadmium 760 further consisting electrodes 716 being configured for deep discharge applications. Other embodiments provide methods and systems for storing electrical energy, comprising the cell platform 756. The cell platform 756 further includes battery configuration for exhibiting higher number of charge/discharge cycles and for exhibiting faster charge and discharge rates. Certain embodiments provide the cell platform 756 further comprises an electrode device 762 comprising at least electrically conductive nano tubes 764 being coated with at least one electrically isolating layer 765. Embodiments further provide the nano-tubes 764 comprising at least a substrate 712 being coated with at least one metallic layer 760. The metallic layer 760 further having a nano-metric pattern and being at least partially exposed at a tip of an electrically conductive core.

The cell platform 754 further comprises at least plurality nano-tubes 764 being configured with flexible electrode devices 762. The flexible electrode devices 762 is further disposed in a guided re-enforced silicon substrate 712. Other embodiments provide each electrode device 764 being configured with plurality of nano-wires/micro-wires 734, each being connected to at least one nano-tube. The nano-tubes further comprise flexible electrode devices 762 being configured to provide electrical communications. Disclosed embodiments further provide the cell platform 756 comprising particles of zinc mixed with an electrolyte consisting of at least potassium hydroxide solution; water, and oxygen from the air to enable reaction at the cathode 751. The reactions may form hydroxyls, which is being migrated into zinc paste and form zinc oxide hydroxide 734. The hydroxide is configured for releasing electrons to the cathode 751. Disclosed embodiments further provide apparatus for enabling reactions, comprising zinc decaying into zinc oxide 734 to provide the releasing of water back into the cell platform 756. The cell platform 756 is being configured so that the water and hydroxyls from the anode 752 are being recycled at the cathode 751. The recycling of the water and the hydroxyls enables the water 766 to serve only as a catalyst to produce maximum voltage.

Embodiments provide the substrate 712 and microfiber material 710 forming the cell platform 756. The cell platform further comprises electro-active material being configured to enable better charge transport. The cell platform 756 further comprises plurality nano-components consisting of nano-particles 767 forming conductive carbon-based nano-clusters 768. The nano-clusters are bound together by a conductive carbon-based cluster binder having high densities of mobile charge carriers such as electrons, electronic acceptors, ionic species. The cell platform 756 further comprises at least a terminal 769, being electrically coupled to the nano-particles 768 for enabling a charge transport and for supplying electrons and electron acceptor sites. Other embodiments provide the cell platform 756 further comprises charge transport 740. The charge transport occurs by means of the electron traveling through the highly conductive and short path of the binders 770. Disclosed embodiments provide the binders in close proximity with the nano-clusters 768 for enhancing the energy and power densities.

Disclosed embodiments further provide the energy transport comprising an enclosed turbine assembly 200 consisting of electric generator device being configured with a cell platform 756. The turbine assembly 200 includes one or more generators 300 each comprising an electric generator machine 800. The electric generator machine 800 includes a stator 802 and a rotor 804. Certain embodiments provide the rotor 804 comprising an inductor 806 being configured with a ring bearing 808. The rotor further comprising apparatus for distributing magnetic poles along a periphery. The rotor 804 further comprises at least central bearing consisting of one or more fan blades 810. The stator 802 being further configured with the rotor 804, comprising bearing windings 812, being communicatively connected to link the magnetic field 814 generated by the magnetic poles 816 when the rotor 804 is caused to rotate without resistance, and at relatively higher speed by a fluid flowing from the fluid generating machine 100. The flow pressure is directed for activating the fan 810. The fan is being supported by the rotor 804, in rotation by the stator 802 through at least a magnetic means of support. Disclosed embodiments further provide the rotor 804 being centrally configured with opening solely occupied by one or more fan blades 810. The fan blades are responsive to controlled fluid flow, being further directed parallel/axially to the axis of the rotor 804 by the fluid generating machine 100. Some embodiments provide the turbine assembly 200 being communicatively connected to the cell platform 756. Certain embodiments provide the cell platform 756 further comprising at least a transformer 755. Other embodiments provide the turbine assembly 200 communicatively connected to grids 820.

Embodiments provide the Wind and Hydropower plant, comprising a renewable energy source that requires no fuel to operate and does not produce any emissions that are harmful to the environment. Disclosed embodiments provide the wind turbines being further made of plastic and metallic materials to prevent any radioactive or chemical impact within the environment. Disclosed embodiments further provide the ventilation apparatus configured for extracting the outside wind to operate the enclosed wind turbine blades. The inflow of air is controllable through the operation of the ventilation apparatus comprising fluid generating machine. The turbines are affixed to take up much less space than conventional wind farms. Disclosed embodiments provide methods and systems that don't produce noise and pollution.

Electricity produced from the disclosed embodiments is cost effective because the wind could be regenerated when there is no wind and more electricity could be generated at any period than that produced from traditional sources like conventional wind farms, natural gas, nuclear power and coal. Maintenance coast for disclosed embodiments is lower, and at best, produces electricity at an efficiency rate far better than conventional wind farms, natural gas nuclear plants and coal. The enclosed wind energy plant is more reliable because the wind could be regenerated when there is no wind. The plant could be operable in every environment, including deserts and icy environment because of the operational configuration and characteristics such as enclosable, controllable wind and thermal adjustment. Electricity could be stored or be produced on demand. The wind is predictable and controllable to produce enough available electricity to meet demands.

Referring to FIG. 17 is seen exemplary embodiments of a charge transport comprising microfiber material 710 being configured with silicon substrate 712. The silicon microfiber comprises cell platform 756. The cell platform 756 comprises nonferrous material 930 embedded in the silicon substrate 712. Multifunctional sensors 970 and MEMS 920 are embedded in the silicon substrate for detection of charge characteristics. The cell platform 756 further comprises nano particles 767 being configured with membranes 900. Disclosed embodiments provide methods and systems for generating electrical energy and for transporting the energy. Some embodiments provide zinc oxide 734. Certain embodiments comprise an analyte 910. Other embodiments provide an investigative agent.

Referring to FIG. 18 is seen a pneumatic component of the turbine generator assembly. The pneumatic component comprises a housing 1, an oil seal 2, an anvil bushing, 3, a retainer ring 4A, a socket retainer 6, an O-ring 7, an anvil 7, a spring 9, a cam 10, a drive ball seal 11, a steel ball 12, a hammer pin 13, a hammer cage 14A, a hammer cage cap 14B, a ball bearing 15, an oil seal 16, a second O-ring 17, front end plate 18, a cylinder 19, a dowel pin 20, a rotor 21, which is communicatively connected to the rotor of the turbine generator apparatus 5, a rotor blade 22, a rear end p[late 23, an ornamental gasket 25, a gasket 26, an end cap 27, at least a cap screw 28, a reverse bushing 29, a reverse valve 30, a third O-ring 31, a locking pin 32, a spring 33, a reverse switch 34, a screw 35, a trigger assembly 36A, a trigger pin 38, a trigger sleeve 39, an oil plug 40, a valve seat 41, a valve stem 42, a throttle valve 43, a valve spring 44, an exhaust deflector 45, air inlet bushing 46, an activation control module 47, a plug 48, a muffler cover 49, a spring 50, a forth O-ring 51, and at least a ceramic silencing ball 52.

Referring to FIG. 19 is seen an exemplary setup system for an enclosed wind turbine system being configured for pneumatic power operations. The pneumatic power operation is a system comprising of an air compressor 500, an air dryer 550, isolation hoses 552, take off lines 554, drain valves 556, branch lines 558, a lubricator 560, a regulator 562, a pneumatic component hookup 564, and a filter 566.

Referring to FIG. 20 is seen further embodiment of the pneumatic component of the turbine generator assembly. Disclosed embodiment provides the pneumatic component comprising a motor housing 1, an operational label 2, a lubrication fitting 3, a reverse valve bushing 4, at least a reverse valve bushing seal 5, a throttle valve assembly 6, a throttle valve face 7, s throttle valve spring 8, a throttle valve stem 9, air strainer assembly 10, speed control module 11, a plug 11A, speed control module pin 12, a reverse valve 13, a reverse valve detent ball 14, a reverse valve detent spring 15, a reverse valve control 16, a reverse valve control screw 17, a pneumatic name plate 18, a rotor 22 in association with a turbine energy generator assembly 19. The turbine generator assembly is disposed with blades 20 and firmly affixed on a tower 21. The pneumatic components further comprise a rear rotor bearing 23, a front rotor bearing 24, a rear rotor bearing retainer 25, a cylinder 26, a cylinder dowel 27, a vane packet 29, a front end plate 30, a rear end plate 31, at least an end plate gasket 32, at least a motor clamp washer 33, a hammer frame assembly 34, at least a hammer pin 35, a hammer frame rear washer 36, at least a hammer 37, at least a hammer case assembly 38, at least a hammer case pilot 38A, at least a hammer case gasket 39, at least a hammer case bushing 40, at least hammer case cap screw 41, at least a hammer case lock washer 42, at least an anvil assembly 43, at least a socket retainer 44, and at least a retainer O-ring 45.

Referring to FIG. 21 is seen further exemplary embodiments of the building structure 20, comprising an enclosed wind turbine plant. Some embodiments provide an exemplary control system 514 for wind turbine 200, and the wind generation apparatus 100. At least one wind generation apparatus comprises an entrance channel. Embodiments provide the wind generation apparatus further comprise a fan assembly 110. Certain embodiments provide the fan assembly 110 further responsive to the operation of a motor apparatus 120. Further comprise apparatus for pulling atmospheric pressure into the building structure 20, in the form of air/wind 150. At least one wind generation apparatus further comprises an exit channel. The control system 514 is in further communication with other communications device 500, 515, 518, and 519 to communicate operational information. Processor(s) 515 are coupled to at least a bus 516 to process the plant and turbine information. Embodiments provide sensors 517, further configured to communicate measurable and immeasurable detection signals to the control system 514. Control system 514 further includes random access memory (RAM) 518. Certain embodiments provide the control system 514 in further communication with other storage device(s) 519. At least one storage device is a cell platform. Certain embodiments provide the storage device 519 in further communication with a power transmission line 001.

The power transmission line further disposed with a switch, a regulator, a DC to DC power inverter, and/or a step up power transformer. RAM 518 and storage device(s) 519 are in further communication with a solar array 700 comprising a hybrid electrical generator assembly 738, each being coupled to bus 516 to store and transfer information and instructions that are to be executed by processor(s) 515. Embodiments further provide the building structure 20 being affixed with a pneumatic system comprising an air compressor 500 and an air dryer 550. At least a take off line 554 is coupled to the dryer 550, in communication with the pneumatic machine 210 being disposed with the turbine assembly 200. Certain embodiments provide the turbine assembly 200 further responsive to fluid pressure force passage through a take off line 554. Some embodiments provide input/output device(s) 520 operable to provide input data to control system 514 to further provide yaw control and pitch control outputs. Other embodiments provide apparatus for providing instructions to at least a memory 521 in association with a storage device 519 via a remote connection that is either wired or wirelessly providing access to one or more electronically-accessible media environment. In some embodiments, hard-wired circuitry can be used in place of or in combination with software instructions. Thus, execution of sequences of instructions is not limited to any specific combination of hardware circuitry and software instructions. Sensor 517 is further interfaced with the turbine assembly 200 to allow control system 514 to communicate with one or more devices.

Embodiments further provide sensor 517 comprising one or more analog-to-digital converters that convert analog signals into digital signals that can be used by processor(s) 515. In one embodiment, the sensor includes sensor interface 522 responsive to signals from a rotor speed to determine device and anemometry information. The present disclosures further provide methods and systems for increasing energy capture to enable renewable electrical energy generation by a wind turbine assembly 200. Each wind turbine assembly 200 is configured to controllably adjusting to the maximum or rated rotational speed set point in response to a measured operational value. Rotational speed further comprises the speed at which the blades 202 rotate about the hub 205. Rated power is the power that the wind turbine generates at a maximum capacity. The maximum capacity is determined by the control system. The rotor is further controlled to rotate in continuous operations during full load operations.

Referring to FIG. 22 is seen further embodiment of the pneumatic component of the turbine generator assembly. Disclosed embodiment provides the pneumatic component comprising a motor housing 1, an operational label 2, a lubrication fitting 3, a reverse valve bushing 4, at least a reverse valve bushing seal 5, a throttle valve assembly 6, a throttle valve face 7, s throttle valve spring 8, a throttle valve stem 9, air strainer assembly 10, speed control module 11, a plug 11A, speed control module pin 12, a reverse valve 13, a reverse valve detent ball 14, a reverse valve detent spring 15, a reverse valve control 16, a reverse valve control screw 17, a pneumatic name plate 18, a rotor 22 in association with a turbine energy generator assembly 201. The turbine generator assembly is disposed with blades 202 and firmly affixed on a tower 203. The pneumatic components further comprise a rear rotor bearing 23, a front rotor bearing 24, a rear rotor bearing retainer 25, a cylinder 26, a cylinder dowel 27, a vane packet 29, a front end plate 30, a rear end plate 31, at least an end plate gasket 32, at least a motor clamp washer 33, a hammer frame assembly 34, at least a hammer pin 35, a hammer frame rear washer 36, at least a hammer 37, at least a hammer case assembly 38, at least a hammer case pilot 38A, at least a hammer case gasket 39, at least a hammer case bushing 40, at least hammer case cap screw 41, at least a hammer case lock washer 42, at least an anvil assembly 43, at least a socket retainer 44, and at least a retainer O-ring 45. Disclosed embodiment further provides the turbine assembly 200, being configured with a pneumatic machine 210. The turbine assembly further comprising a generator portion 201, a blade 202, a nose cone 204, a hub 205, and a stabilizer 206.

Referring to FIG. 23 is seen further embodiment of the pneumatic component of the turbine generator assembly. Disclosed embodiment provides the pneumatic component comprising a motor housing 1, an operational label 2, a lubrication fitting 3, a reverse valve bushing 4, at least a reverse valve bushing seal 5, a throttle valve assembly 6, a throttle valve face 7, s throttle valve spring 8, a throttle valve stem 9, air strainer assembly 10, speed control module 11, a plug 11A, speed control module pin 12, a reverse valve 13, a reverse valve detent ball 14, a reverse valve detent spring 15, a reverse valve control 16, a reverse valve control screw 17, a pneumatic name plate 18, a rotor 22 in association with a turbine assembly 200 being disposed with energy generator assembly 201. The turbine generator assembly 200 is further disposed with blades 202, and firmly affixed on a tower 203. The pneumatic components of the pneumatic machine 210 further comprise a rear rotor bearing 23, a front rotor bearing 24, a rear rotor bearing retainer 25, a cylinder 26, a cylinder dowel 27, a vane packet 29, a front end plate 30, a rear end plate 31, at least an end plate gasket 32, at least a motor clamp washer 33, a hammer frame assembly 34, at least a hammer pin 35, a hammer frame rear washer 36, at least a hammer 37, at least a hammer case assembly 38, at least a hammer case pilot 38A, at least a hammer case gasket 39, at least a hammer case bushing 40, at least hammer case cap screw 41, at least a hammer case lock washer 42, at least an anvil assembly 43, at least a socket retainer 44, and at least a retainer O-ring 45. Embodiment further provide the turbine assembly 200 being responsive to the operation of the pneumatic machine 210

Referring to FIG. 24 is seen an exemplary setup system for an enclosed wind turbine system being configured for pneumatic power operations. Embodiment provides an exemplary series/parallel connection for the turbine assembly. The pneumatic power operation is a system comprising of an air compressor 500, an air dryer 550, isolation hoses 552, take off lines 554, drain valves 556, branch lines 558, a lubricator 560, a regulator 562, a pneumatic component hookup 564, and a filter 566. The turbine assembly 200, being affixed on a mounting base 207, and disposed within the building structure.

Disclosed embodiment further derives energy from changes in pressure being generated by a compressed air system. Within the compressed air system, the efflux of air from a storage medium is held under pressure, wherein the compressed elastic body of the fluid may or may not assume any internal fluid motion from the storage medium because in other embodiment, this body by virtue of its elasticity and design simplicity is capable of producing other motions in other heavy body.

Compressed air is clean, safe, simple, and would provide efficient propellant to operate wind turbine generators. There are no dangerous exhaust fumes or any other harmful byproducts associated with this system when using compressed air as a utility energy source or as a propellant for wind turbine operations. Compressed air is a non-combustible, non-polluting utility source of energy. The most important fact to realize with disclosed embodiment is that the very act of compressing air yields free energy.

This free energy occurs because, according to the mathematical formula PT/V. It is important to note that in some embodiments, the energy required to compress the air is converted to HEAT, while the air is also compressed to produce mechanical energy by expanding it again from its storage medium. The storage medium, in other embodiments, is the compressor tank, which is being refilled nonstop at cut-on pressure and turns back off at cut-off pressure when the tank pressure reaches 125 psi as per a particular design requirement. The system of operation for disclosed embodiment is a continuous process, allowing the compressed air to be converted into mechanical energy, then to electrical power at a controllable operational pressure. The mechanical system here is a pneumatic system which, in other embodiment, is built into the housing of the generator assembly. Disclosed embodiments provide a new technological method that efficiently converts the travelling compressed air energy moving through a structured environment. Certain embodiments provide methods of moving the energy stored from compressed air system to generate electrical power without producing greenhouse byproduct gases or other pollutants. Disclosed embodiment provide a compressed air method that produces smooth energy translation with more uniform flow force, unlike equipment that involves translatory forces in a variable force field.

Some embodiments provide a system that develops high pressure force at low temperature and the pressure force, in the form of energy, is stored for communication with the pneumatic portion of the system, enabling rotation of the generator to produce renewable electrical energy. Though the system is not one hundred percent closed, still its operation and its output may be looked at as a perpetual-motion machine. In other embodiment, the compressor portion is affixed with the pneumatic apparatus, and may run off solar energy or a 12 volt battery to operate the compressor motor. Yet, in other embodiments, the pneumatic apparatus is affixed in the generator housing for communication with the generator.

Embodiments further provide advanced renewable energy methods having at least a motor that generates energy in the form of high pressure at low temperature. The pressure here is compressed air pressure which utilizes compressibility factor. The compressed air is then stored in a storage medium or being channeled through at least an exit channel comprising an accelerator. Regarding the stored compressed air, the stored energy may be channeled through at least a quarter inch hose at a regulated pressure using the kinetic theory of fluid. There is an effect of the transfer of momentum, and there is a change of energy due to the variation in compressed air passing from one momentum to another.

The pressure running through the quarter inch hose is directed to drive the pneumatic device, which is in communication with the electrical generator. The generator produces electrical energy at a controllable rate. In a prototype model developed by the inventor, the machine shuts of when the storage pressure is 125 psi, and kicks back on when the storage pressure has exceeded its threshold minimum. Certain embodiments provide a renewable energy method that does work by only changing the nature of the motion. The device extracts energy first from seemingly a perpetual source and is capable of moving “perpetually for as long as the first source of energy endures. The compressed air is being generated as fluidic energy which is then converted back into mechanical energy to drive at least a generator that produces electrical energy at a controllable pressure displacement rate or pressure flow rate.

Though compressed air or pneumatic devices are characterized by high power-to-weight or power-to-volume ratio, in some embodiment constant air volume is pumped from the compressor chamber, and the volume decreases often as the generator produces electrical energy. This decrease causes an increase in both the pressure and the temperature of the air. Compressed air finds a broad field of applications for which its response and speed makes it ideally suited for renewable electrical energy generation. In other embodiments, air is drawn in from the atmosphere and compressed to final pressure in a single stroke to arrive at flow pressure.

Flow is equivalent to the quantity of compressed air conveyed in a given section per unit of time.

Q=A1×V1=A2×V2

Q: flow (cfm)
A: flow section (ft²)
V: speed (ft/min)

The international system of flow is cubic meters/second (m3/s), but we generally use 1/s, m3/h or cfm. This varies according to several factors, and, in particular, to the air pressure, the hose diameter or section area, and the length/ID of the pipe, which conveys the compressed air.

When air is compressed, the compressed air pressure is greater than that of the atmosphere “Its surrounding.” The compressed air characteristically attempts to return to its normal state during operation of the disclosed system. Since energy is required to compress the air that energy is released as the air expands and returns to atmospheric pressure. As high pressure drives air into the pneumatic portion, rotation is enabled for the generator to extract mechanical energy and also for the mechanical energy to continuously rotate the generator. The mechanical energy reduces the pressure of the expended air. The mechanical energy being extracted by the generator is converted to electrical energy in a convenient manner. The overall design challenge is to optimize the air flow, the shape and rotation speed of the generator to maximize the overall efficiency of energy recovery. Some embodiment provides a system that requires the internal energy stored in compressed air to be directly convertible to work so as to generate electrical power because air compressors are embodied to compress air to higher pressures capable of harnessing that electrical energy.

Referring to FIG. 25 is seen an exemplary setup system for an enclosed wind turbine system being configured for pneumatic power operations. Embodiment provides an exemplary series/parallel connection for the turbine assembly. The pneumatic power operation is a system comprising of an air compressor 500, an air dryer 550, isolation hoses 552, take off lines 554, drain valves 556, branch lines 558, a lubricator 560, a regulator 562, a pneumatic component hookup 564, and a filter 566. The turbine assembly 200, being affixed on a mounting base 207, and disposed within the building structure. At least a control system 514 is provided for communication with the turbine assembly 200, and the compressor 500. Certain embodiment provides the control system 514, in further communication with an output meter 208, and a set of battery pack. Some embodiment provides the control system 514 in further communication with an electrical grid.

Referring to FIG. 26 is seen further exemplary embodiments of the wind generation apparatus 568 being disposed in a building structure 20. The building structure further comprises an enclosed wind turbine plant. Embodiment provides an exemplary series/parallel connection for the turbine assembly. The pneumatic power operation is a system comprising of an air compressor 500, an air dryer 550, isolation hoses 552, take off lines 554, drain valves 556, branch lines 558, a lubricator 560, a regulator 562, a pneumatic component hookup 564, and a filter 566. The turbine assembly 200, being affixed on a mounting base 207, and disposed within the building structure.

While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the following claims;

What is claimed:

1. An electrical generation system; comprising:
at least a building structure;
at least a turbine assembly;
at least an apparatus for generating fluid pressure force affixed within said building structure;
at least a communication apparatus for controlling the rotational speed for said turbine assembly; and
said turbine assembly responsive to the operation of said apparatus for generating fluid pressure force for generating renewable electrical energy.

2. The electrical energy generation system of claim 1, wherein said apparatus for generating fluid pressure force further comprises at least a wind generator apparatus.

3. The electrical energy generation system of claim 1, wherein said turbine assembly further comprises variable rotational speed set point.

4. The electrical energy generation system of claim 1, wherein said turbine system further disposed with sensors arranged for communication with said communication apparatus to obtain at least one of: measurable operational parameters; immeasurable operational parameters.

5. The electrical energy generation system of claim 1, wherein said turbine assembly further enclosed in said building structure responsive to said apparatus for generating fluid pressure force.

6. The electrical energy generation system of claim 1, wherein said communication apparatus further comprising means for comparing at least one mechanical/electromechanical operational parameter for adjusting the speed and electrical energy output of said turbine assembly.

7. The electrical energy generation system of claim 1, wherein said building structure further comprises at least one of: a compressed air medium; a central monitoring station; wherein said building structure further configured to selectively permit adjustment of at least one of: said turbine assembly rotation; controlling said apparatus for generating fluid pressure force; in response to an external requirement and/or demand, producing electrical energy.

8. The electrical energy generation system of claim 6, wherein at least one measured operational parameter further comprises at least one of: at least a generator speed; at least a power output; at least turbulence intensity within said building structure; at least fluid inlet and outlet speed for said building structure; at least a generator torque; at least ambient temperature for said building structure; at least inlet and outlet fluid pressure differential; at least a generated fluid density; at least a component temperature; at least the electrical current in generator rotor; at least the electrical current in generator stator; at least the voltage in generator rotor; at least the voltage in generator stator; at least the power output factor; at least a drive train vibration; at least a yaw position; and/or any combinations thereof.

9. The electrical energy generation system of claim 7, wherein the external requirement further comprises at least one of: at least a power factor; external temperature conditions; external fluid force conditions; a site property conditions; an electrical requirement; maximum power output; electrical power demand; fluid force condition; maintenance condition; mechanical conditions; electromechanical conditions; and/or any combinations thereof.

10. The electrical energy generation system of claim 1, wherein said sensor further disposed on or in close proximity to said turbine assembly.

11. The electrical energy generation system of claim 1, wherein said apparatus for generating fluid pressure force further comprises at least one of: a compressor for generating compressed air pressure; a wind generation apparatus; a pumped fluid pressure; a conduit pressure flow channel; and/or any combination thereof.

12. The electrical energy generation system of claim 1, wherein said apparatus for generating fluid pressure force further comprises at least one of: compressed air pressure force generation apparatus, pneumatic pressure means.

13. The electrical energy generation system of claim 1, wherein said turbine assembly is further operable by at least one of: the pneumatic pressure means to generate renewable electrical energy; compressed air means; coupling means.

14. The electrical energy generation system of claim 13, wherein said pneumatic pressure means further comprises at least one of: compressed air apparatus; a pneumatic apparatus being responsive to the operation of said compressed air apparatus; pneumatic apparatus being responsive to compressed air pressure.

15. The electrical energy generation system of claim 1, further comprising nano technology solar cell apparatus, compressed air means for generating electrical energy.

16. The electrical energy generation system of claim 15, wherein said nano technology solar cell apparatus further comprises at least a non ferrous material having excellent electrically conductive properties, each material being embedded in a silicon substrate, and wherein said silicon substrate is etched/fused in at least one of: a nano fiber material; a nano fiber glass substrate; a microfiber material; and/or any combinations thereof.

17. The electrical energy generation system of claim 1, wherein said building structure further comprises at least an energy medium comprising at least one of: a heat exchanger for cooling at least one of: the building medium, the turbine assembly; pressure force environment; electrical energy production plant; and/or any combination thereof; and wherein the heat exchanger is located inside the building structure and further configured to control a temperature and humidity condition.

18. The electrical energy generation system of claim 1, wherein said apparatus for generating fluid pressure force further comprises at least a machine each comprising a generator, wherein each generator further comprising a first channel for air-inlet and at least a second channel for air-outlet, and wherein each generator further responsive to said fluid pressure force for generating electrical energy.

19. The electrical energy generation system of claim 1, wherein said apparatus for generating fluid pressure force is in association with said building structure to enable at least one of: energy transport platform; method for generating controllable energy; means for controlling said turbine assembly operational parameter; method for reducing unscheduled electrical outage; method for monitoring turbine operations; method for scheduling turbine maintenance; method for withstanding extreme environmental conditions; non-seasonal energy production means; and/or any combination thereof.

20. The electrical energy generation system of claim 1, wherein said apparatus for generating fluid pressure force further comprises at least one of: method for enhancing wind reliability; method for increasing energy generation; method for producing regenerative fluid pressure force; method for producing regenerative energy; method of compressing atmospheric pressure in at least a structure for communication with said turbine assembly to generate renewable electrical energy; methods of channeling atmospheric pressure into a structure, compressing the pressure within the structure, and providing at least a turbine assembly responsive to the compressed air; means for allowing the compressed air to return back to atmospheric pressure; at least a pathway for compressing atmospheric pressure to generate electrical energy; a mobile wind turbine assembly device; and/or any combination thereof.

21. The electrical energy generation system of claim 1, wherein said apparatus for generating fluid pressure force further comprises a compressed air method of generating renewable electrical energy.

22. The electrical energy generation system of claim 1, wherein said apparatus for generating fluid pressure force in association with said turbine assembly, further comprising a pneumatic method of generating electrical energy.
